(19) United States
(12) Patent Application Publication
(10) Pub. No.: US 2016/0035187 A1
(43) Pub. Date: Feb. 4, 2016

(54) INTERACTIVE FANTASY WAGERING GAMING SYSTEM

(71) Applicant: LAMPS PLUS, INC., Chatsworth, CA (US)

(72) Inventors: ERIK SWANSON, Woodland Hills, CA (US); Jon Knarreborg, North Hollywood, CA (US)

(73) Assignee: LAMPS PLUS, INC., Chatsworth, CA (US)

(21) Appl. No.: 14/449,609

(22) Filed: Aug. 1, 2014

(51) Int. Cl. G07F 17/32

(52) U.S. Cl. CPC G07F 17/3244

(57) ABSTRACT

An interactive fantasy wagering gaming system and method wherein a virtual community of registered users participate by establishing leagues or contests and place wagers using fantasy gold coins and fantasy league dollars which wagers are tracked to determine the winner of a specific league or contest.

### FIELD OF THE INVENTION

The invention is directed generally to the field of fantasy sports games and more particularly to such a system in which the registered users may place wagers utilizing fantasy currency.

### BACKGROUND OF THE INVENTION

Fantasy sports leagues are very well known and provide an interactive system in which the average sports fan is able to participate in the role of a virtual general manager. Basically, league participants organize with friends or other associates and draft or select players for their fantasy team in accordance with a selection scheme which has been generated and approved. Usually the participants draft players and then utilizing these players to participate in the fantasy sports league with the outcome being based upon the individual statistical results. These types of games have been extended to every different type of professional and amateur sports league.

Wagering on sporting events is usually considered by those participating in a particular event as an activity that enhances the sports fans enjoyment of the activity. Such wagering relates to the placing of wagers or bets by a plurality of individuals on the outcome of an event, wherein those participating share a betting pool minus a percentage taken out for the management or administrations of the wagering activity. Most such wagering activity is solitary and is difficult for players to evaluate their performance relative to the performance of others. However, contest based games such as fantasy sports games have the main focus of competition against other human competitors and encourage the individual to evaluate his performance against the performance of others. These interactive games are played on the internet. In some jurisdictions wagering is legally acceptable on fantasy sports games and the exchange of money occurs in those circumstances. However, many individuals who would like to wager on sports contest do not wish to risk the loss of money but would still like to have the thrill of wagering and the competition against other human competitors to determine who is the most accurate in picking the winner of a sports contest. As a result there has been developed an interactive electronic online gaming system directed to the utilization of fantasy currency allowing the participating individuals to place wagers on the outcome of sports events. The participants organize themselves into individual leagues having a predetermined number of individuals and the system determines which of the users has the greatest amount of success selecting a winner or outcome of various contests. Typically this interactive online gaming system is directed to wagering on the outcome of organized sports activities such as football, baseball, basketball, hockey and the like with the duration of the league being based on the duration of the fantasy wagering season of the sport.

Such prior art interactive gaming systems, however, have limitations as to how the leagues may be generated and the manner in which the participants are selected. There is therefore a need for an interactive gaming system in which registered users of the system may form leagues which are unrestricted as to the activity upon which wagers are to be placed. It is also desirable for a registered user to be able to recruit others to join an interactive system and participate in the leagues.

### BRIEF SUMMARY OF THE INVENTION

A method and system provides an interactive fantasy wagering gaming system in which a plurality of users establish a virtual community interconnected with a communication network. The system provides the ability for each of the registered users to link to the registered users social media networks. An administrator is provided for the system to oversee the activity of the users. The users establish public and private leagues with the public league being established only by the administrator but the private leagues may be established by the users and may be directed to any contest or portion of a contest as desired by the one establishing the league. Each Registered user is issued a predetermined amount of fantasy gold coins which may be used to participate in the leagues. Upon joining a particular league the registered user is issued a predetermined amount of fantasy league dollars which are used only to place wagers on the outcome of specific events in that specific league. The wagers placed and the outcome of the wagers in that specific league are tracked to determine the winner in that particular league. A registered user may also earn additional fantasy league dollars by inviting friends from the user's social media network and having those friends join the league. A registered user may also further earn additional league dollars by allowing certain of the league wagers to be automatically shared with their social media accounts.

### BRIEF DESCRIPTION OF THE DRAWINGS

FIG. 1 is a block diagram illustrating a system which may be utilized in accordance with the principals of the present invention;

FIG. 2 is flow chart illustrative of an algorithm showing activity of when a user first comes to the online site;

FIG. 3 is a flow chart illustrative of an algorithm showing the user joining the site;

FIG. 4 is a flow chart illustrative of an algorithm showing a user logging into the site;

FIG. 5 is a flow chart illustrative of an algorithm showing a user logging out of the site;

FIG. 6 is a flow chart illustrative of an algorithm showing the user accessing the league news page;

FIG. 7 is a flow chart illustrative of an algorithm showing the user viewing a news article applicable to a specific league;

FIG. 8 is a flow chart illustrative of an algorithm showing the user clicking onto a page showing all of the odds for a particular league event;

FIG. 9 is a flow chart illustrative of an algorithm showing the user who has clicked onto an activity feed;

FIGS. 10A through 10D is a flow chart illustrative of an algorithm showing a user clicking onto a page which illustrates the activities of the various players, with FIG. 10A showing the hottest players and the bankroll leaders, FIG. 10B showing the highest bankroll and the leaders based on accuracy, FIG. 10C showing the newest members and the league winners, and FIG. 10D showing the recent contest winners;

FIG. 11 is a flow chart illustrative of an algorithm showing a specific players card;

FIG. 12 is a flow chart illustrative of an algorithm showing a user clicking onto a page showing the trophies for a particular player;

FIG. 13 is a flow chart illustrative of an algorithm showing a user having clicked onto a specific trophy;

FIG. 14 is a flow chart illustrative of an algorithm showing the manner in which a user may obtain fantasy gold coins;

FIG. 15 is a flow chart illustrative of an algorithm showing the user clicking onto a page to view all of the leagues;

FIG. 16 is a flow chart illustrative of an algorithm showing the ability for the player to search for a league;

FIGS. 17A and 17B is a flow chart illustrative of an algorithm showing a specific league page with FIG. 17A showing the league home page and FIG. 17B showing betting history, forum and players;

FIG. 18 is a flow chart illustrative of an algorithm showing all contests in which the user may participate;

FIG. 19 is a flow chart illustrative of an algorithm showing the user being able to browse all contests;

FIG. 20 is a flow chart illustrative of an algorithm showing the user viewing a specific contest page;

FIG. 21 is a flow chart illustrative of an algorithm showing a specific user clicking onto his leagues and contests;

FIG. 22 is a flow chart illustrative of an algorithm showing user viewing all of those users' friends;

FIG. 23 is a flow chart illustrative of an algorithm showing the ability of the user to generate a message and transmit it to another user;

FIG. 24 is a flow chart illustrative of an algorithm showing the user being able to view all notifications applicable to that user;

FIG. 25 is a flow chart illustrative of an algorithm showing the activity of a user who has created a league and is to manage that league;

FIG. 26 is a flow chart illustrative of an algorithm showing the managing user promoting the league;

FIGS. 27A and 27B is a flow chart illustrative of an algorithm showing the wagering activity in a specific league with FIG. 27A showing such activity with respect to a particular league and FIG. 27B showing the wagering in a grudge match;

FIG. 28 is a flow chart illustrative of an algorithm showing the manager of the league being able to view the league players;

FIG. 29 is a flow chart illustrative of an algorithm showing the user viewing the various forum posts for a specific league;

FIGS. 30A and 30B is a flow chart illustrative of an algorithm showing a leagues sports book with FIG. 30A showing the initiation of the sports book and FIG. 30B showing the conclusion of the sports book;

FIG. 31 is a flow chart illustrative of an algorithm showing a leagues schedule;

FIG. 32 is a flow chart illustrative of an algorithm showing a particular leagues activity feed;

FIG. 33 is a flow chart illustrative of an algorithm showing a leagues leader board;

FIG. 34 is a flow chart illustrative of an algorithm showing a user creating a league;

FIG. 35 is a flow chart illustrative of an algorithm showing a user creating a grudge match; and

FIG. 36 is a flow chart illustrative of an algorithm showing a user creating a contest.

### DETAILED DESCRIPTION OF THE INVENTION

The present invention provides a system and method which is accessible online to all interested individuals to allow them to organize themselves into groups interested in wagering on specific events. The events generally of interest are those related to various sports, both amateur and professional. The interested individuals upon accessing the system would be required to register and upon registering would create a profile, which among other things would indicate the particular sporting events of interest to that individual. Typically upon registering the individual would be automatically included in those public leagues in which an interest has been expressed. The system and method would include an administrator who is an employee and who oversees the activity of the users and as part of the duties of the administrator would create public leagues which would be available to any interested registered user to join. The administrator does not have to join the league which he/she has created and does not have to establish a minimum or maximum number of players for the league. Also, the administrator may decide that there shall be no gold coin buy in required for the league and the administrator is the only one who can establish this parameter for a league.

After registration, a registered user may create a league which is of interest to that individual and which that individual believes others may also have an interest in. A league may be directed to a specific sport or a specific event upon which the individuals who join the league may wager with regard to the outcome of that event or game. The system and method of the present invention is extremely flexible and provides the ability to the creator of the league to establish the parameters for the league. The individual registered user who does in fact create a league will then be identified as the Commissioner for that particular League. The parameters which the Commissioner may establish for that particular League would include the amount of gold coins required to buy in as a participant of that league, the style of play that will be utilized in that league, the league dollars which will be provided to each user who registers to play in that particular league, the minimum and maximum league dollar amount for each wager, the start and stop time for the League and the deadline by which an individual player must join the League. As above indicated, the Commissioner can arbitrarily select any specific sport or specific event that he or she desires and may then arbitrarily set the start and stop time for that event which will then be the League. That is, for example, if the Commissioner of the specific league is interested in baseball he/she is not limited to having the time period for the league extend for the entire baseball season. Rather the Commissioner of that particular league may set an arbitrary time such, for example, as two weeks or even a particular series between two teams. Those interested in that particular segment of the baseball season would then be able to wager regarding the outcome of the teams participating during the specific time established for that league.

In accordance with one aspect of the present invention there is provided fantasy currency which comprises fantasy gold coins as a master currency and fantasy league dollars. The fantasy gold coins cannot be purchased by a registered user but can be earned or issued through various activities. The fantasy gold coins cannot be traded or sold but they can be redeemed for actual prizes and can also be used to spend on certain functions available in the system and upon joining leagues. The fantasy gold coins are initially issued in a predetermined amount to each registered user upon joining the system. Additional fantasy gold coins may be obtained by the user linking to his/her social media, inviting friends to join the system, watching sponsor videos, winning a league with a gold coin prize pool or earning trophies. The fantasy gold coins may be used to join a league in which the Commissioner of the league has established a fantasy gold coin buy in or joining a particular contest in which a specific event is involved and in which the Commissioner of the contest has established a fantasy gold coin buy in as well as other uses.

The fantasy league dollars is a secondary fantasy currency which is issued to a user when the user joins a league or a contest. Each user who joins that specific league or that specific contest is issued the same amount of fantasy league dollars. Those fantasy league dollars may be used only for wagers by that registered user during the duration of that specific league or contest. The wagers made by the registered users who have joined a particular league or contest are tracked to determine the outcome of the wagers and to determine a winner of the particular league or contest which would typically be that particular registered user who has accumulated the largest amount of fantasy league dollars. It has been found in some instances that when a registered user joins a league and commences wagering his Fantasy League Dollars, that if he quickly loses all of his Fantasy League Dollars, he may lose interest and leave the system. As a means of mitigating this potential, the Commissioner establishing the League may have the League function in a manner in which points are awarded after each round of wagering and the League Dollar Bankroll is then reset for each of the players in that particular League going into the next round. Points are awarded based upon the ranking of the individual player with respect to all of the players in the particular League. For example, if in round 1 of a several-round League, a player accumulates 40,000 League Dollars based upon the bets and the results of the wagers established and the success of those wagers during that round and as a result of the accumulation of 40,000 League Dollars, the player is ranked Number 5 out of the 100 players in the League, the system would award that particular player 95 points, then the players in the League would engage in the second round with each of the players having the same amount of League Dollars which was set by the Commissioner at the time he/she established the League. This manner of awarded points would then be accomplished after each round and at the end of all of the rounds for that particular league, the one who has accumulated the largest number of points, as opposed to a largest number of League Dollars, would be considered the winner of that League. As can be seen by resetting the League Dollar Bankroll to the value established by the Commissioner after each round would keep the interest of all of the players in that League even though an individual player may have a bad round. As indicated above, there would then be issued fantasy gold coins depending upon the particular manner in which the creator of that league or contest has determined that the prize pool should be shared. For example, if the buy in for a specific league is one thousand gold coins and there are twenty registered users who have joined that specific league, then the total prize pool would be twenty thousand gold coins. The creator of that particular league could have determined that the first place winner would receive 40% of the pool, second place 25% of the pool, third place 15% of the pool, fourth place 12% of the pool and fifth place 8% of the pool. The twenty thousand fantasy gold coin pool would then be distributed accordingly, namely sixteen thousand gold coins, ten thousand gold coins, six thousand gold coins, forty-eight hundred gold coins and three thousand-two hundred gold coins to first through fifth place winners respectively.

As above indicated, the system and method is extremely flexible with the ability to create leagues and as above indicated the administrator may create public leagues or private leagues. When the administrator creates a public league there is no limit to the number of registered users who can participate in that league. If a registered user creates a public league, however, the number of participates in that public league may be limited in number depending upon the rules which have been established by the administrator. When a user creates a private league there is typically a limit to the number of registered users who can participate. In addition thereto when a user creates a league that league cannot become activated until a predetermined minimum number of registered users have agreed to join that particular league. An additional flexibility of the system and method of the present invention is that two registered users may establish a grudge match which is effectively a private league between these two individuals. This typically would be as a result of two individuals who have been wagering in different leagues and are rated extremely close in their success rates. As a result one of the individuals may then challenge the other to a grudge match and as such this particular private league between these two individuals would be established.

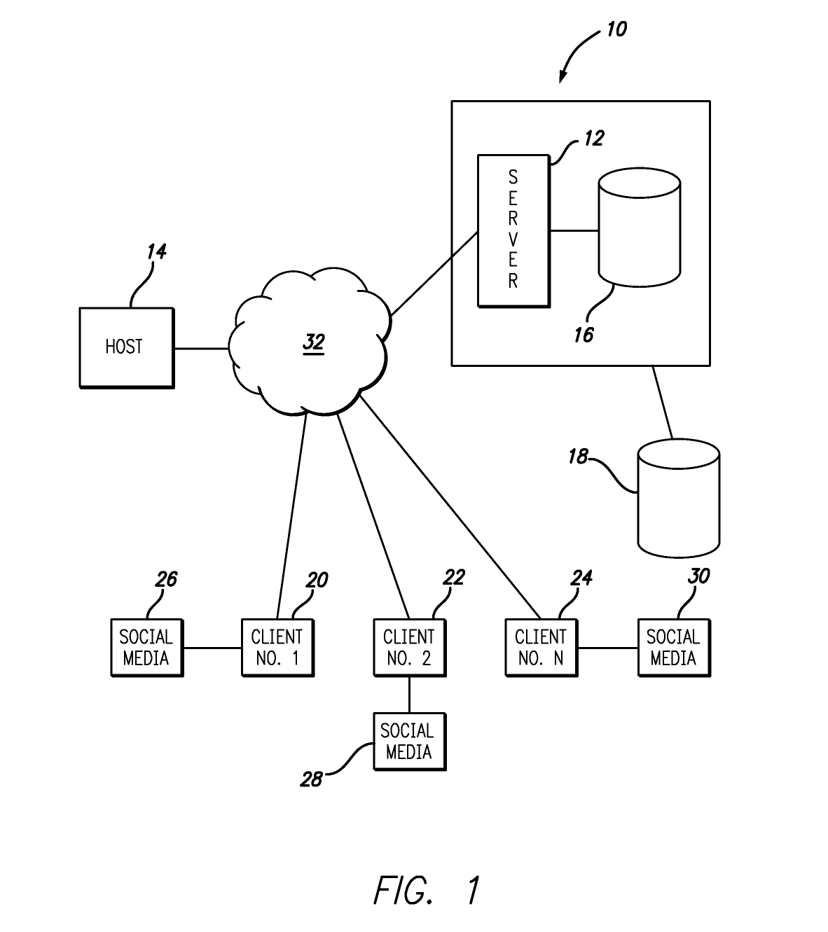

Referring now more specifically to the drawings and particularly to FIG. 1, there is illustrated in block diagram form a system which provides the ability for forming the virtual community of registered users to become involved in the interactive fantasy wagering gaming system as above described. As is in shown in FIG. 1, the system 10 includes a server 12 for performing various tasks such as processing input from the host 14. The system 10 also includes a data storage device 16 which is utilized for storing users profiles, league results, contest results and the like. The system 10 may also be in communication with an external device 18 to obtain results of sporting events, contests and other pertinent information. A plurality of users such as indicated as client number 1 at 20, client number 2 at 22 and client number “N” at 24 are also in communication with the server 12. As indicated through the indication of client number “N” the number of clients which may be in communication with the system and the server 12 is indefinite and can include any number of individuals who desire to register as a user for participating in fantasy wagering in accordance with the principles of the present invention. Each of the clients is also provided a link to that clients social media, such for example as social media 26 of client number 1, social media 28 for client number 2 and social media 30 for client number “N.” The host 14 and the clients 20, 22 and 24 are in communication with the system 10 by way of the internet, intra-net or other wireless communication network 32. The host and the clients typically utilize personal computers but it should also be recognized by those skilled in the art that these participants may use any of a variety of well known computing and communicating devices to create and participate in the interactive fantasy wagering gaming system in accordance with the principles of the present invention.

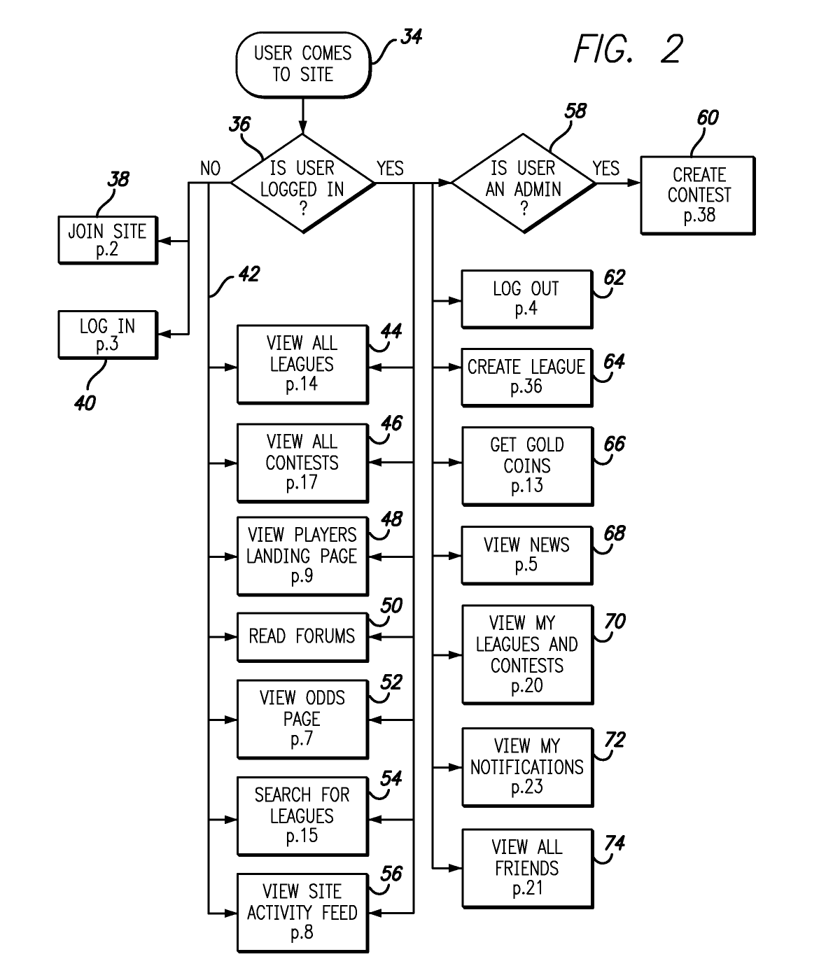

Referring now more particularly to FIG. 2, there is illustrated an algorithm showing what happens when an interested individual first accesses the website of the present invention. As therein shown the user 34 comes to the site and when this occurs the system makes the query as shown in 36 as to whether or not this individual user is logged in. If the answer to that question is no, then the user is directed to join the site as shown at 38 and once that occurs to log in as is shown at 40. In some instances, the user before deciding to join the site and log in may wish to have an opportunity to further become acquainted with the system. As a result as is shown at 42 the user is given an opportunity to view all of the leagues that are in existence as shown at 44 and to view all of the contests that are in existence as shown at 46. In addition thereto, as shown at 48 the prospective member has an opportunity to view the players landing page, to read the various forums that have been generated as shown at 50 and to also view the odds page as shown at 52 to see what the odds are with regard to potential wagers that may be made with regard to various leagues. The user may also have an opportunity to search for specific leagues as shown at 54 and to also view the site activity feed as shown at 56. On the other hand, if when the user comes to the site and the query of is the user logged in as shown at 36 is answered in the affirmative then that user also has an opportunity to browse the various elements as shown at 44 through 56 and above referred to. In addition thereto, the additional query at shown at 58 is made as to whether or not the user who has logged in as a system administrator. If the answer to that query is yes, then as shown at 60 the administrator is given the opportunity to create a contest. The logged in user may also be given an opportunity to log out as shown at 62 or to create a league as shown at 64. As previously discussed upon logging into the site a registered user may also be issued additional fantasy gold coins as is shown at 66. The logged in user may also have an opportunity to view the news as shown at 68 or to view the leagues and contests which are of interest as shown at 70. He may also want to view notifications as shown at 72 and to view all of the friends as shown at 74.

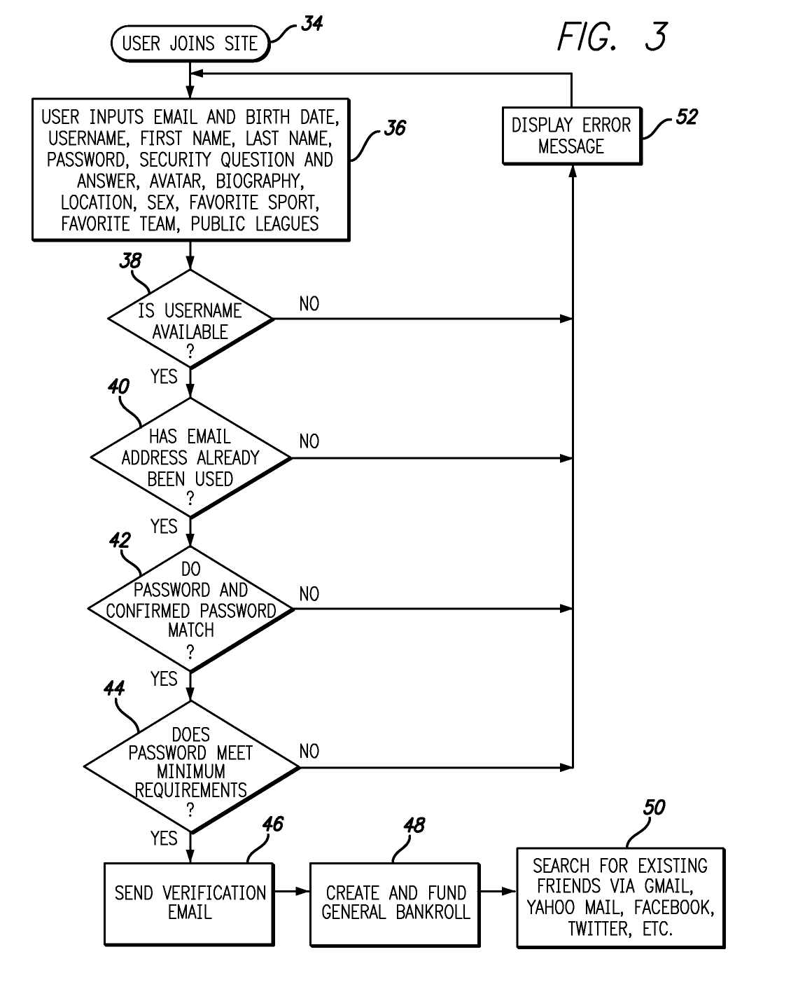

When the user 34 coming to the site decides to join the site such is accomplished as is illustrated in FIG. 3 to which reference is hereby made. As therein shown, there is provided an algorithm for the user to join the site by entering various information, as is shown at 36. This information is utilized to establish a profile for that particular user and includes a large amount of personal information. One requested information is a user name, the availability of which is then checked as shown at 38. If the user name is available then a query is entered to determine whether or not the e-mail address is available as shown at 40. If in fact the e-mail address is available then a query is made as shown at 42 to determine whether the password and the confirmed password match. If in fact this is confirmed then the query is made as to whether or not the password meets the minimum requirements which have been established for the system as is shown at 44. If the password does meet the minimum requirements then a verification e-mail is sent as is illustrated at 46.

As has been referred to earlier when a user joins the site the user is issued a predetermined amount of gold coins and such is illustrated at 48. As shown at 50 a search can then be made to find existing friends via various social media such as yahoo, Facebook, twitter and so forth as shown at 50. If any of the inquiries as indicated at 38, 40, 42 and 44 are answered in the negative then an error message is displayed as shown at 52 and directed back to the user so the user may then correct the error such for example as by changing the user name, selecting a different e-mail address or a different password as may be required.

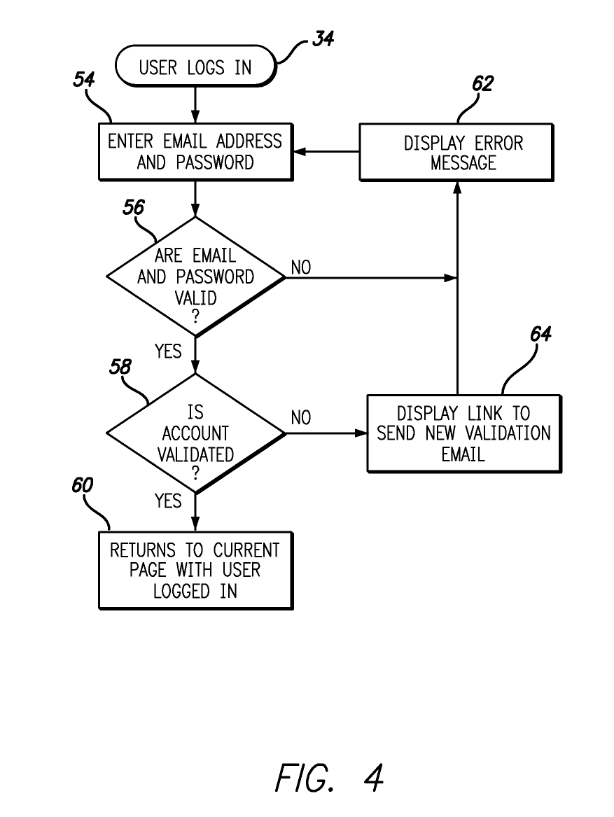

Once the user has joined the site as outlined in FIG. 3, then the user may log in as is illustrated in FIG. 4 to which reference is hereby made. As is therein shown, there is provided an algorithm for the user 34 to log in by entering that users e-mail address and password as shown at 54. The query is then made as shown at 56 as to whether or not the e-mail and password that have been entered are in fact valid. If the answer is in the affirmative then the query is made as to whether or not the account is validated and if that is in fact answered in the affirmative as shown at 60 the system shows that that user has been logged in. If the e-mail and password are not valid then an error message is displayed accordingly as shown at 62 and if the account is not validated then the link is displayed to send a new validation e-mail as is shown at 64 along with displaying the error message accordingly.

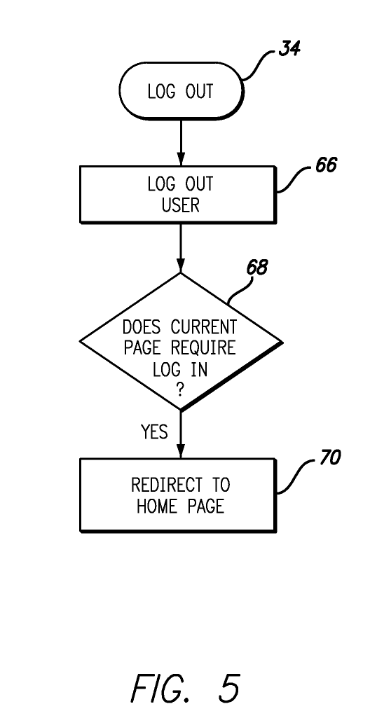

As above referred to in conjunction with FIG. 2, if the user is logged in, one of the options provided is that the user may log out. If the user desires to do so such can be accomplished with the algorithm as shown in FIG. 5 to which reference is hereby made. The user 34 logs out as shown at 66 and the query is made as shown at 68 as to whether or not a current page requires a log in and if the answer to that is in the affirmative, then the user is redirected to the home page as shown at 70.

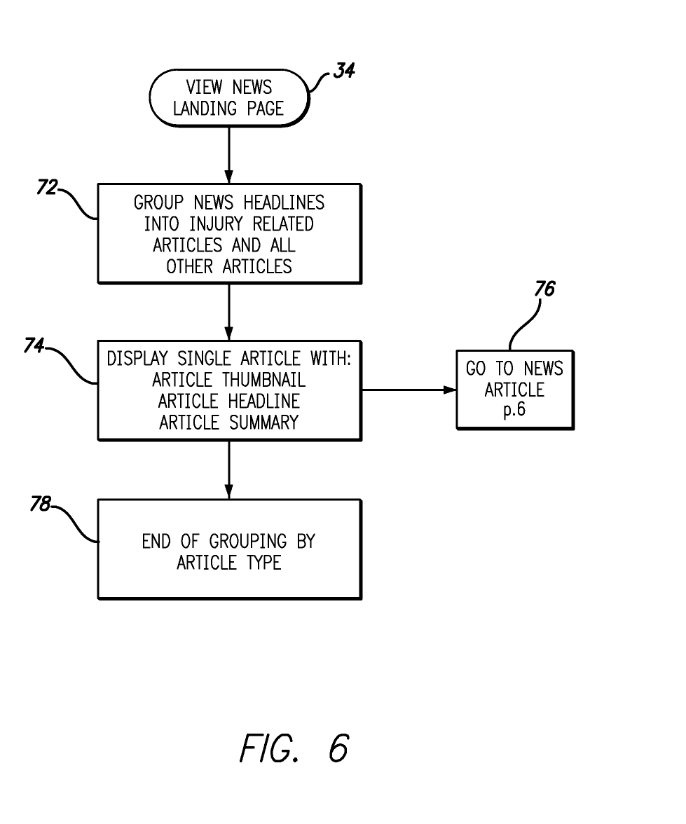

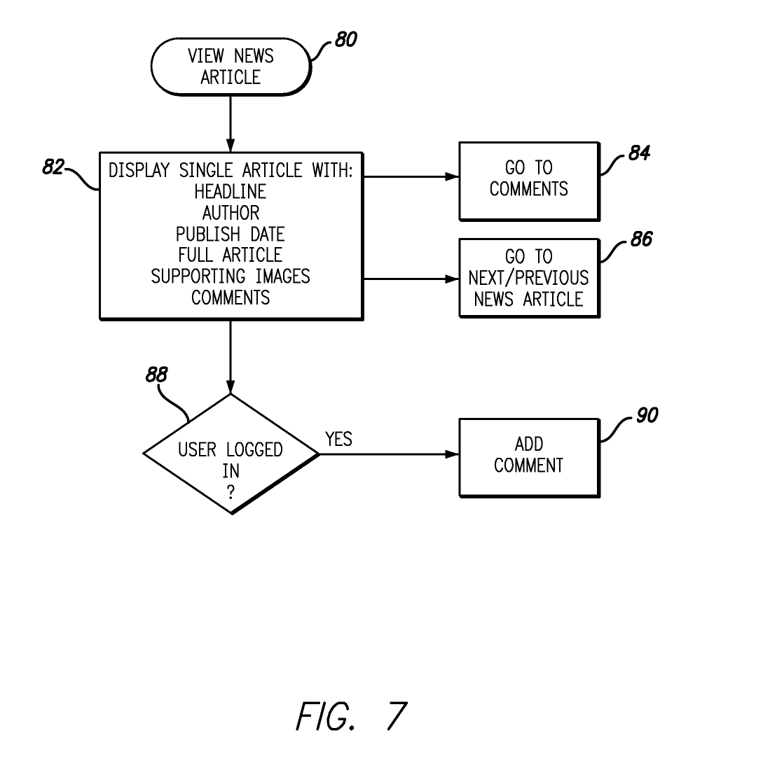

As indicated in FIG. 2, if the user is logged in one of the options given, as is shown at 68 is for the user to view the news landing page which is illustrated in more detail in FIG. 6 to which reference is hereby made. As in therein shown, there is provided an algorithm for the user to view news landing page as shown at 34. As is shown at 72 the news is grouped into various specific categories which may be of interest to the user. The user may then select which articles are of interest and that article is selected as is shown at 74 and may be displayed with a thumb nail, a headline or a summary which the user may then review and determine whether or not he/she is interested in reviewing or reading the article in more detail. If such is desired then the user may go to that news article as shown at 76 and read it in detail. If the user is not interested after reviewing the thumb nail, headline, summary and going to a specific article then the news landing page is terminated as the end of the grouping by article type as shown at 78. If, however, the user does decide to go to a particular news article then such is accomplished as is shown in FIG. 7 to which reference is hereby made.

As is shown in FIG. 7, there is provided an algorithm for the user to view the particular news article is illustrated at 80. As is shown at 82, the full article is provided along with comments which may have been made by others about that particular article. If the user wishes to do so he/she may click onto the comments and this will provide a review in detail of the comments as is shown at 84. If, however, the user does not wish to look at those particular comments the user may click onto the next news article or the previous news article to review that as is shown at 86. After reviewing the article as shown at 82 the query is made as to whether or not the user is logged in as shown at 88 and if such is the case the user may then add comments regarding the news article as desired as shown at 90.

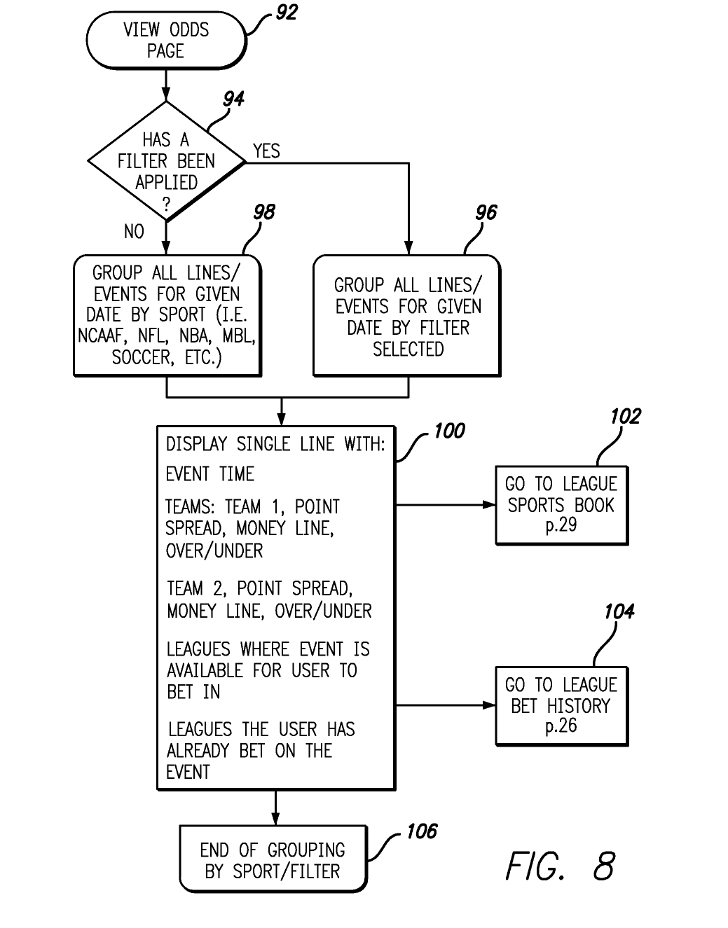

As indicated with the discussion with regard to FIG. 2, when the user comes to the cite, either logged in or not, the user may view the odds page as indicated at 52. If that is clicked on then the view odds page algorithm as illustrated in FIG. 8 is provided to which reference is hereby made. As therein shown the view odds page 92 may have a filter applied so that only certain specified events will be shown to the user. Thus, the query as to whether a filter has been applied is set forth as shown at 94. If the answer to the query is yes, then as shown at 96 all lines or events for the given date as specified by that filter will be grouped and displayed. If the answer is no, then as shown at 98 all lines/events for the given date will be displayed by the particular sport involved for that league. The display is shown at 100 and includes the teams, the point spread, the money line, the over under for the teams as listed, the leagues where the event is available for the user to bet on is also illustrated as well as the league's where the user has already bet on the event. The user is also directed, if the user desires to do so, to go to the leagues sports book as shown at 102 or go to the league bet history as shown at 104. If these are not clicked on then the end of the grouping by the sport or filter is indicated as shown at 106.

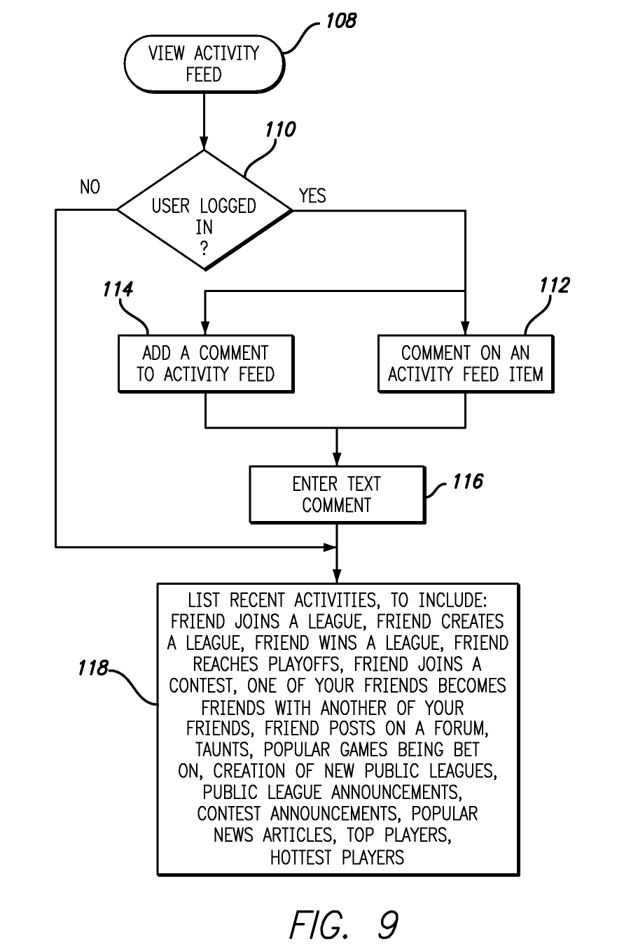

As indicated in the discussion with regard to FIG. 2, the user, when he comes to the site and is either logged in or not, may be given the opportunity to view the site activity feed as shown at 56. If the view activity feed is clicked on then the view activity feed as shown in FIG. 9, to which reference is hereby made, will be activated. As is therein shown, there is provided an algorithm for the view activity feed 108. The query of whether the user is logged in or not is shown at 110. If the user is logged in then the user will have the opportunity to comment on an activity feed item as shown at 112. In addition, thereto the logged in user will have the opportunity to add a comment to the activity feed as shown at 114. If either of those events occurs and the user does comment on an activity feed item or adds a new comment to the activity feed then once that is accomplished the comment as provided by the user is entered onto the activity feed as shown at 116.

If the user is not logged in or alternatively if the user is logged in and makes the comments and enters the text then the recent activities are listed as shown at 118 and these may include such things as a friend of the user has joined the league, a friend of the user creates a league, a friend of the user wins a league or reaches the playoffs in the league, a friend joins a contest, one of your friends becomes friends with another of your friends, a friend of the user posts on a forum, taunts, popular games being bet on are listed for the benefit of the user, the user is also notified of the creation of new public leagues thus giving the user an opportunity to join those leagues, public league announcements are made, contest announcements are made, popular news articles are referred to and both the top players and the hottest players are identified. When the specific friend's activity as above referred to is provided to the user the friends name in all instances becomes a link to their profile and when a league is referred to the league name is linked to the league page. For a game to be identified as being popular more than a predetermined (as determined by the creator of the league or the administrator) number of bets by the users must have been placed and the same would be true for the hot or most popular contest. The number of wagers having been made may also be qualified by having been made within a predetermined time frame. For a sports article to be considered popular more than a predetermined number of the users must have shared, viewed or commented on that article within a specific time frame. For a player to be listed as a top player or the hottest player the overall accuracy of the player's wagers within a specified minimal number of games or within the last predetermined number of games respectively is required.

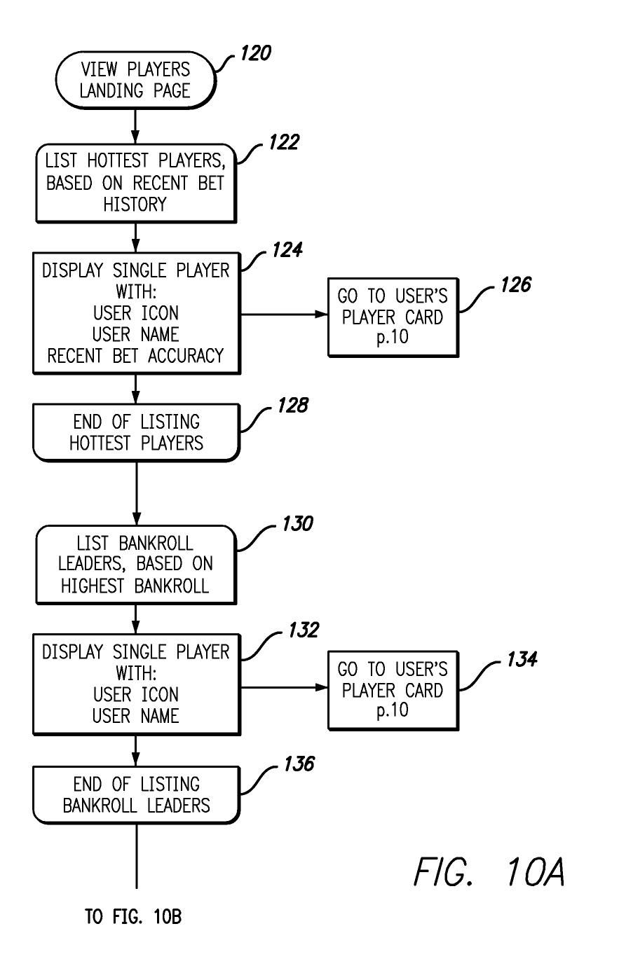

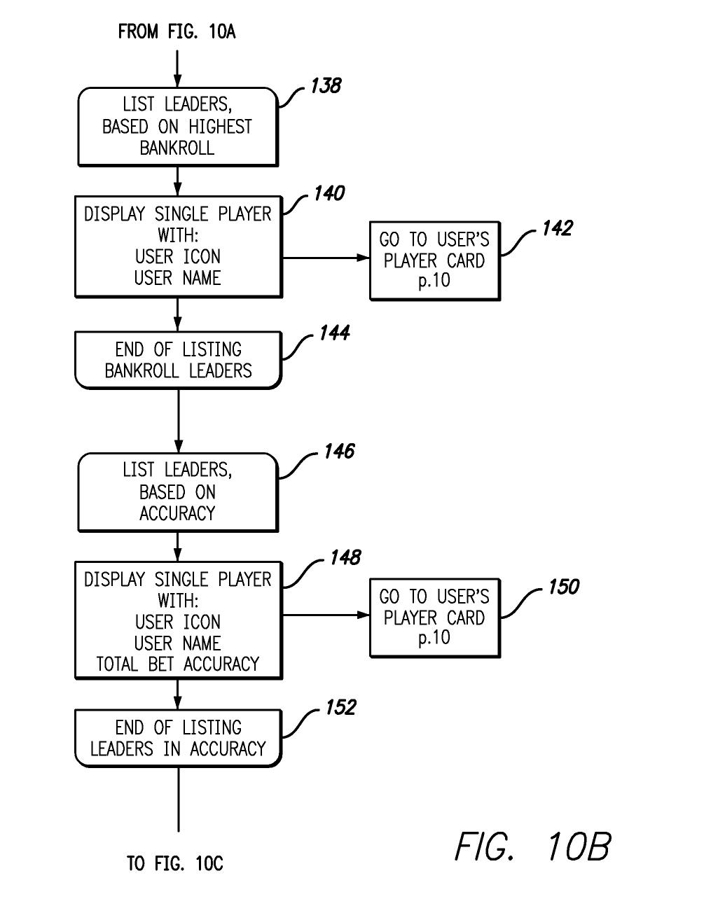

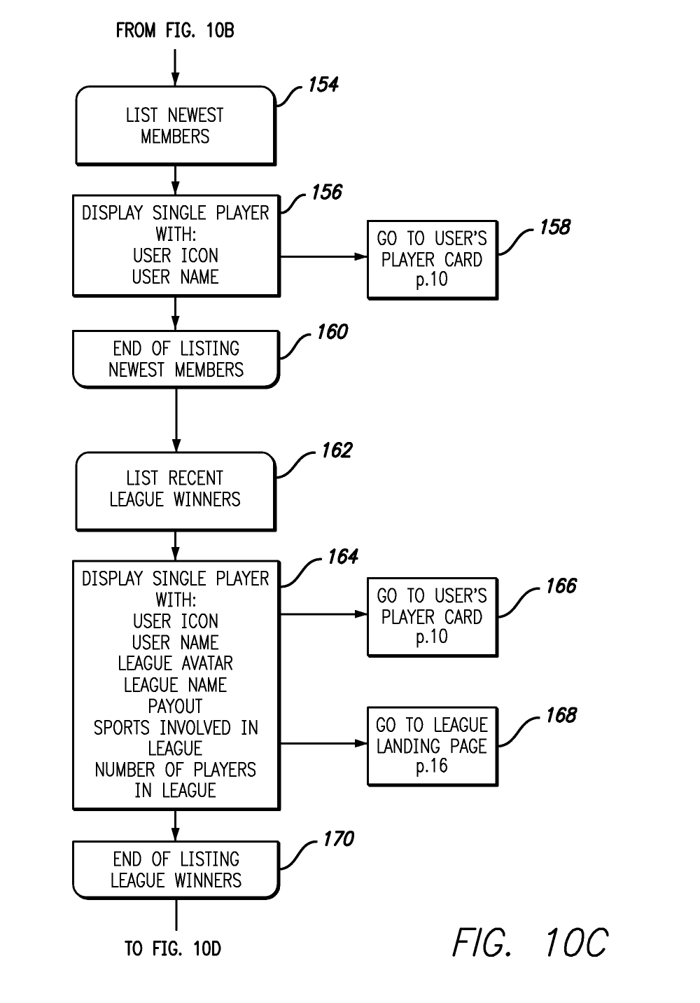

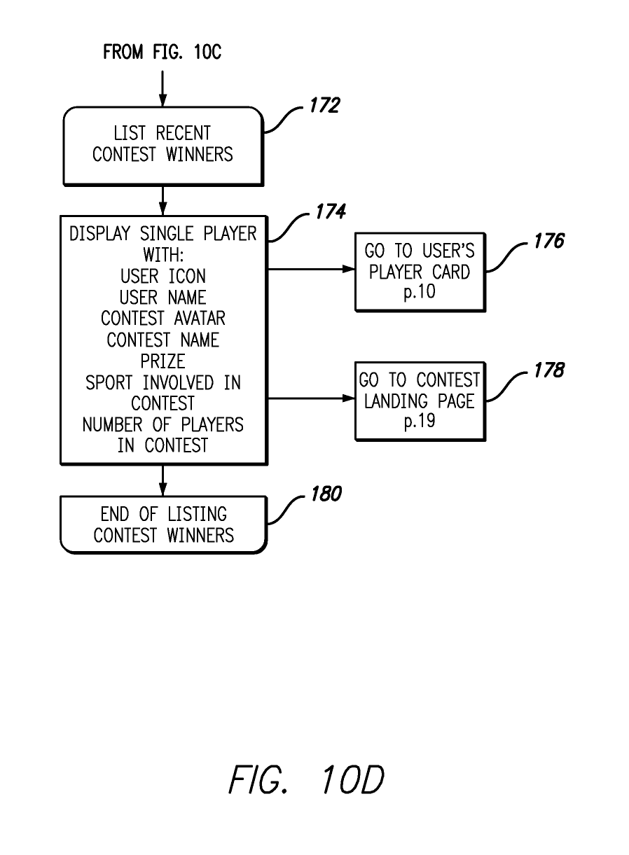

As above indicated in conjunction with the description and discussion of FIG. 2, the user whether logged in or not is given the opportunity to view a players landing page as shown at 48. If the viewer clicks on the view players landing page then the user has displayed for him or her an algorithm for the viewers landing page as shown at 120 of FIG. 10 to reference is hereby made. As illustrated in FIG. 10, once the viewer's landing page is activated there will be displayed a list of the hottest players which as above indicated will be those players who have had the most accuracy in placing their wagers within a specified recent period of time. Once the players are listed as indicated at 122, the user may click on a particular identified player which will then display this single player by identifying the player by name and user icon and the recent bet accuracy of that player as shown at 124. As shown at 126 the user may then if more detailed information is desired click on go to the user's player card as shown at 126. Subsequently, the listing of the hottest players will be terminated as shown at 128.

As will also be shown on the viewer's landing page there will be a list of bank roll leaders as shown at 130 based on the greatest amount of gold coins which the players have. Once this list of the bank roll leaders is displayed the user may click upon a particular one of the bank roll leaders and when that is done that particular individual is identified and displayed as shown at 132 with the user's name and icon. If desired the user may then go to that players player card as shown at 134. Subsequently the listing of the bank roll leaders is terminated, as is shown an 136.

In addition, when the players landing page is viewed there will also be listed the leaders based on the highest bank roll as shown at 138. Then again the highest bank roll leader desired by the user may be clicked on and his individual user name will be displayed as shown at 140. Again the user may be given an opportunity to go to the users player card as shown at 142. Subsequently the listing of the highest bank roll leader will be terminated as shown at 144.

In addition, when the viewer's landing page is activated as shown at 120 the leaders based on accuracy of the wagers made will be displayed as shown at 146. The user may then click upon any one of that list of leaders and the leader clicked upon will be displayed as shown at 148 with the leader's name, icon and the total bet accuracy of that leader. The user may then go to that user's player card as shown at 150. Subsequently the listing of the leaders based upon the bet accuracy is terminated as shown at 152.

As an additional information provided when the players landing page is clicked on as shown at 120 will be to provide a list of the newest members, as is shown at 154. When the user reviews this list of the newest members the user may desire to find additional information with regard to anyone of those members as listed and may then click on that particular member. When such occurs the information regarding that single player by the user name and icon will be displayed as shown at 156. The user will then have an opportunity to go to that user's player card as shown at 158. Subsequently the listing of the newest members is terminated as shown at 160.

As an additional bit of information, when view players landing page is clicked on as shown at 120 there will be a list of the recent league winners displayed as is shown at 162. The user may then click upon anyone of these recent league winners which is listed and when this occurs that league winner information will be displayed providing the league winners identification, the league name, what the payout was, what the sports involved in that league was and what the number of players in the league was, all as shown at 164. The user may then have an opportunity, if desired to go to that users player card as shown at 166 or further to go to that particular leagues landing page as shown at 168. Subsequently the listing of the league winners will be terminated as is shown at 170.

As an additional piece of information, when the user clicks on to view the players landing page as shown at 120 there would be a list of the recent contest winners as shown at 172. When the user desires the user may click upon anyone of the contest winners and when such is done that specific winner's identification by name, icon and the like will also be listed as shown at 174. Also, with this listing will be identifying the name of the contest, sport involved in the contest and the number of players in the contest. Also, the user may elect to go to this specific user's player card as shown at 176 or may click on the particular contests landing page as shown at 178. Subsequently the listing of the contest winners will be terminated, as is shown at 180.

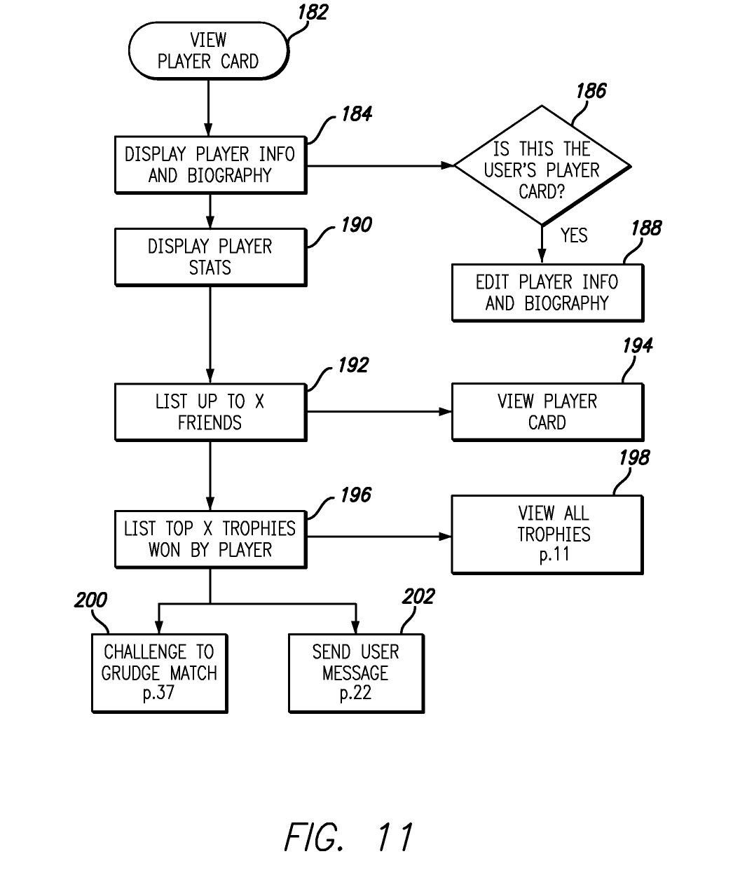

When the user clicks on to a user's player card in anyone of the instances as illustrated in FIG. 10 and above discussed, an algorithm for the player card involved with that particular individual will be displayed as is illustrated in FIG. 11 to which reference is hereby made. As, as indicated at 182 the view player card is clicked upon and the players information and biography will be illustrated as shown at 184. The query will be made as shown at 186 as to whether or not this is the user's player card, that is the specific user that has been viewing the information as set forth on the players landing page as shown at FIG. 10. If this is the user's player card then the user will be given the opportunity to edit the information and biography that appears on that specific user's player card as shown at 188. If, however, it is not the users player card then the user who has been identified in the activity as discussed with regard to FIG. 10 will have the statistics of that specific player listed as is shown at 190. Also, there will be listed a predetermined number of that players friends as identified by that players information as is shown at 192. If anyone of the friends as listed is then clicked upon by the user then that particular friend's player card may be shown and clicked upon as shown at 194 to provide for more and greater information with regard to that particular friend who has been identified. If the friend is a part of the user's social media network, the user may send a message to the friend to join the league. If the friend does affirmatively respond and join the league, then the user will be issued additional league dollars which the user can then use in placing wagers. In addition, the trophies which have been won by the player will be listed as shown at 196. If it's desired to view all of the trophies then that may be clicked upon as shown at 198. If the user after reviewing all of the information with regard to the player whose player card has been identified desires to challenge this particular player to a grudge match such may be done as shown at 200 or alternatively the user may desire to send a message to the player as indicated at 202.

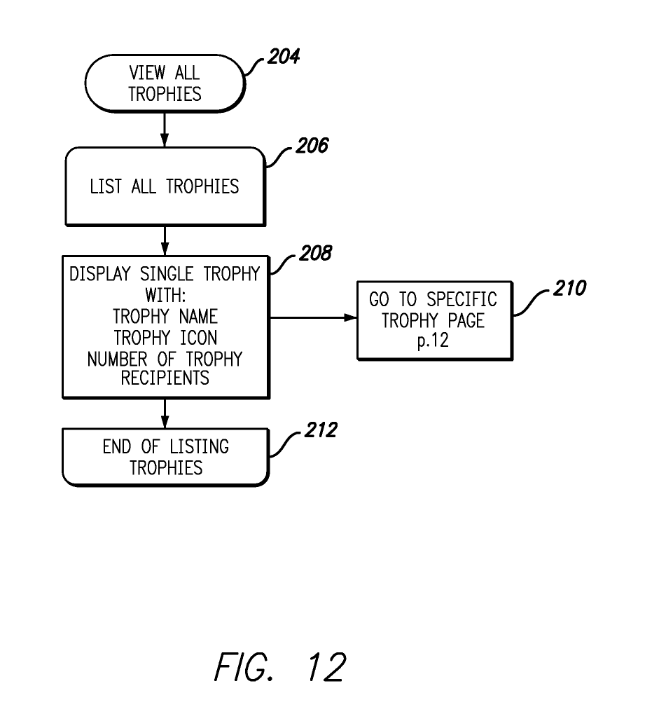

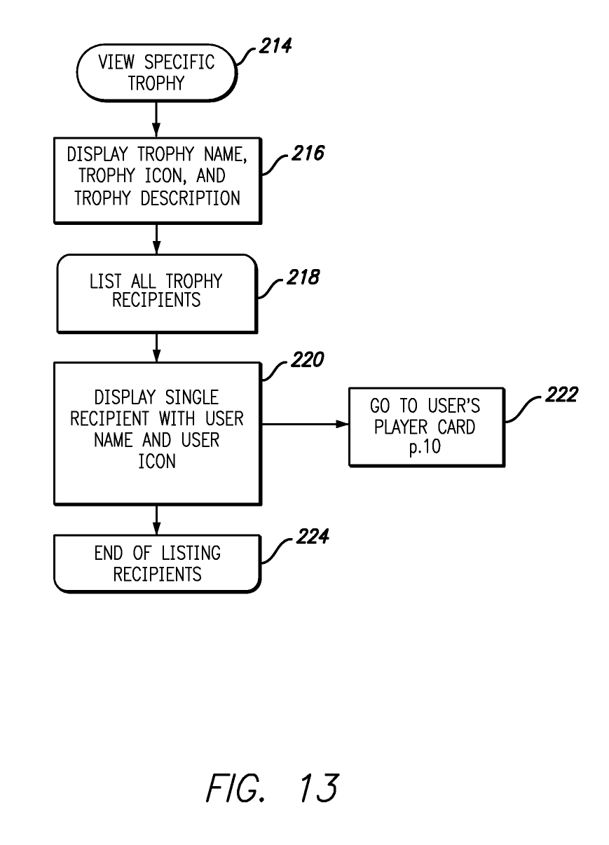

If the user clicks on the view all trophies as indicated at 188 in FIG. 11 then an algorithm regarding that information will be displayed as illustrated in FIG. 12 to which reference is hereby made. When the view all trophies is clicked on as shown at 204 then the list of all the trophies will be provided as shown at 206. When all of the trophies are listed the user may then click upon a specific one of the trophies to get additional information with regard thereto. When this is done that single trophy will be displayed as shown at 208, it will also provide the trophy name, the trophy icon and the number of recipients of that specific trophy. If desired the user may then go to the specific trophy page as indicated at 210. Subsequently, all the listing of the trophies will be terminated as shown at 212.

If the user does click on the go to a specific trophy page as shown in FIG. 12 then the specific trophy page algorithm will be illustrated as shown in FIG. 3 to which reference is hereby made. As therein shown, if the view specific trophy page is clicked upon as illustrated at 214 then that specific trophy will be displayed as is shown at 216 providing the trophy name, the icon of that trophy and the detailed description of the trophy. In addition, all of the individual users who have received this particular trophy will be listed as is shown at 218. If it is desired, the user may then click upon anyone of the recipients of the trophy and if that is done then that specific recipient of the trophy will be listed and displayed as shown at 220 with that users name and icon. The user may then decide to go to the specific user's player card who has received the trophy, if such is desired, as shown at 222. Subsequently, the end of the listing of the recipients of the trophy will be terminated as is shown at 224.

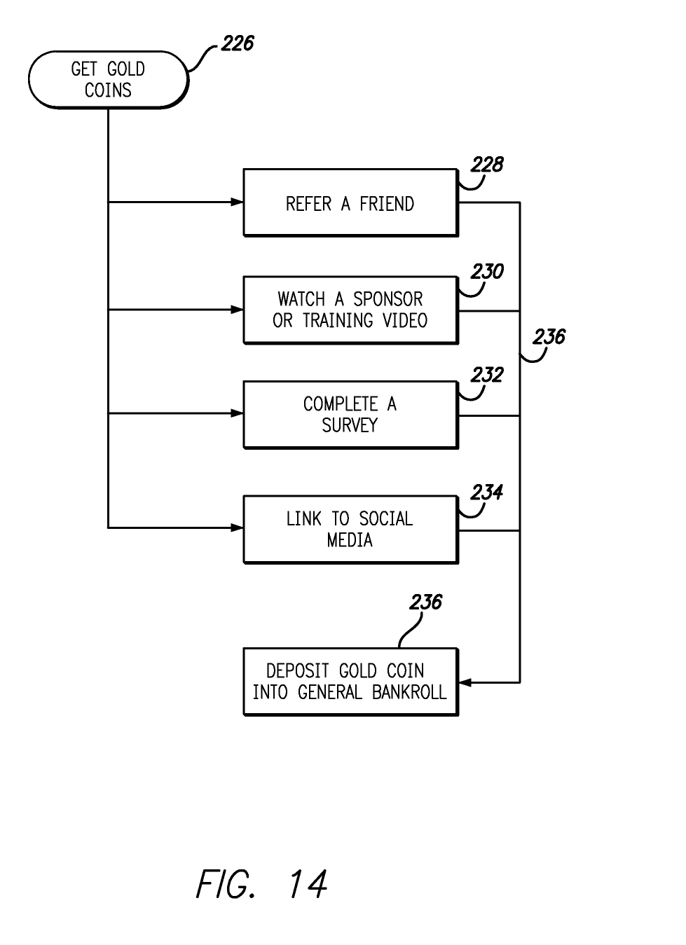

As indicated in the discussion with regard to FIG. 2, when the user comes to this site and has joined and logs in he will be issued a predetermined number of fantasy gold coins. To do this he would click upon the get gold coins as shown at 66 in FIG. 2. When such is done an algorithm is illustrated as shown by the flow chart in FIG. 14 to which reference is hereby made. As therein illustrated, the user will click on get gold coins as shown at 226. In addition to being issued the specific predetermined number of gold coins as a result of joining the site the user may obtain additional gold coins by referring a friend as shown at 228 or by watching a sponsor or a training video as shown at 230 or by completing a survey as shown at 232 or by linking to the users social media, as shown at 234. As is indicated by 236 when any of these events occur the fantasy gold coins associated with that event will then be deposited into the gold coin general bank roll of that particular user as is shown at 236. When a user joins a league in which the creator of the league, as part of the rules, require a fantasy gold coin buy in, then the gold coins from the general bank roll of that user are used to join that league. In doing so the system checks to see if there are enough fantasy gold coins in that user's general bank roll to cover the entry fee for the league. If the funds are not sufficient then the user is alerted that they were not able to join the league because of the insufficient funds. If the fantasy gold coins in the users general bank roll are sufficient then the entry fee is deducted from that users fantasy gold coin general bank roll.

Once a league has been completed if the league has a prize for making the playoffs then the prize in the form of the fantasy gold coins is deposited in that users gold coin general bank roll if the user does win and goes into the playoffs.

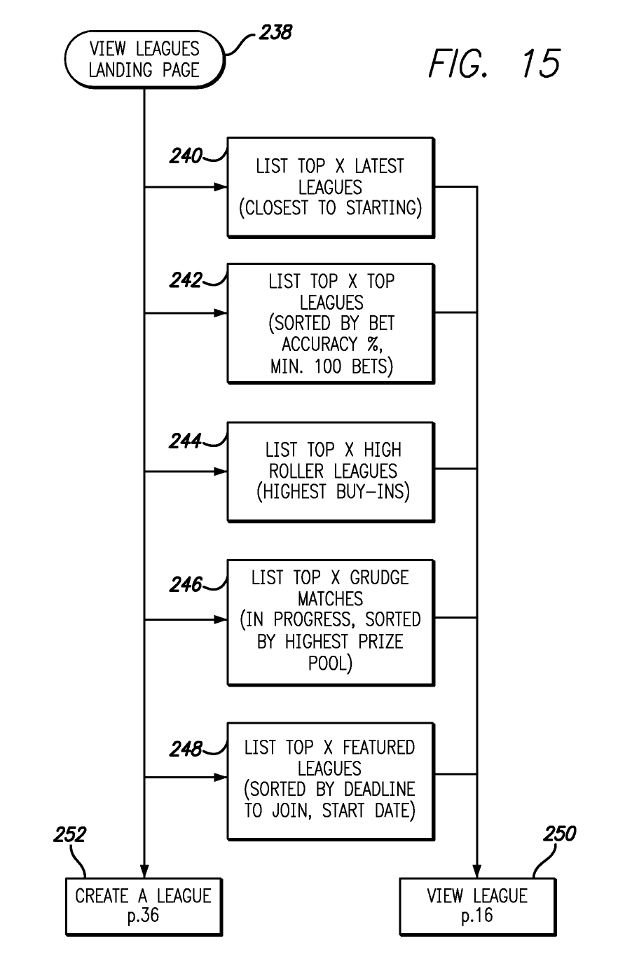

When a user comes to the site whether logged on or not as shown in FIG. 2, the user may wish to view all leagues as indicated at 44 in FIG. 2. If the user does click on view all leagues then the user would be directed to view the leagues landing page as illustrated in FIG. 15 to which reference is hereby made. As is therein shown, the view leagues landing page algorithm flow chart is shown at 238. A list will be displayed of the predetermined number of the latest leagues, that is, those which are the closest to starting as shown at 240. In addition, there will be displayed a predetermined number of the top leagues which are sorted by the bet accuracy percentage as shown at 242. There would also be a list of a predetermined number of the high roller leagues, that is, those having the highest fantasy gold coin by in as shown at 244. There will also be listed a predetermined number of the grudge matches which are in progress sorted by the highest prize pool as shown at 246. There will also be listed the predetermined number of the featured leagues which are sorted by the deadline to join and the start date as shown at 248. When any of these listings of the leagues are provided to the user the user may then click upon the league as identified in the listing as indicated at 240-248. When the player does click upon any of the names for the specific leagues then the user is allowed to view that particular league page as shown at 250. The user would also be placed in a position to create a league if that user desires to do so as in indicated at 252.

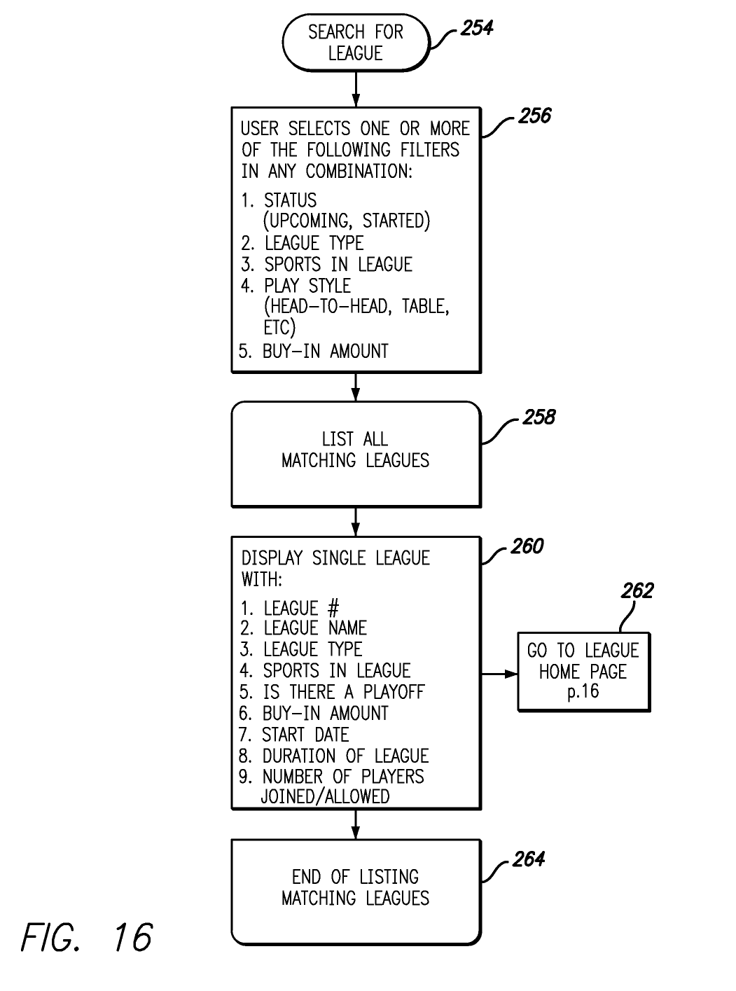

Again when the user comes to the site, whether logged in or not, the user has the opportunity as shown in FIG. 2 to search for leagues as indicated at 54. If the user does click onto the search for leagues then he would be directed to the flow chart as shown in FIG. 16, which shows an algorithm, to which reference is hereby made. As therein shown, the search for league is clicked on as shown at 254. The user is presented a number of filters which may used in sorting the leagues that will be displayed. The filters provided for utilization by the user would be the status such as these which are upcoming or those which have already started of the particular leagues, the league type, the sports in the league, the play style of the league, that is head-to-head, table, etc. and the buy in amount all as indicated at 256. The user may now select one or more of these filters or any combination of the filters desired and when the search is conducted these filters will determine the list of leagues which match those filters that will be listed as shown in 258. Out of the list of matching leagues displayed as shown in 258, the user may click on anyone of the particular leagues as desired and when that occurs that league will be displayed as shown at 260 along with the league number, league name, the league type, the sports in the league, whether there is a playoff for that particular league, what the buy in amount is, what the start date is, what the duration of the league is and the number of players who have joined or the number players that are allowed to join this particular league. The user after viewing this information then may go to that leagues home page, if desired as shown as 262. Subsequently, the listing of the matching leagues in accordance with the filters which have been selected will be terminated as shown at 264.

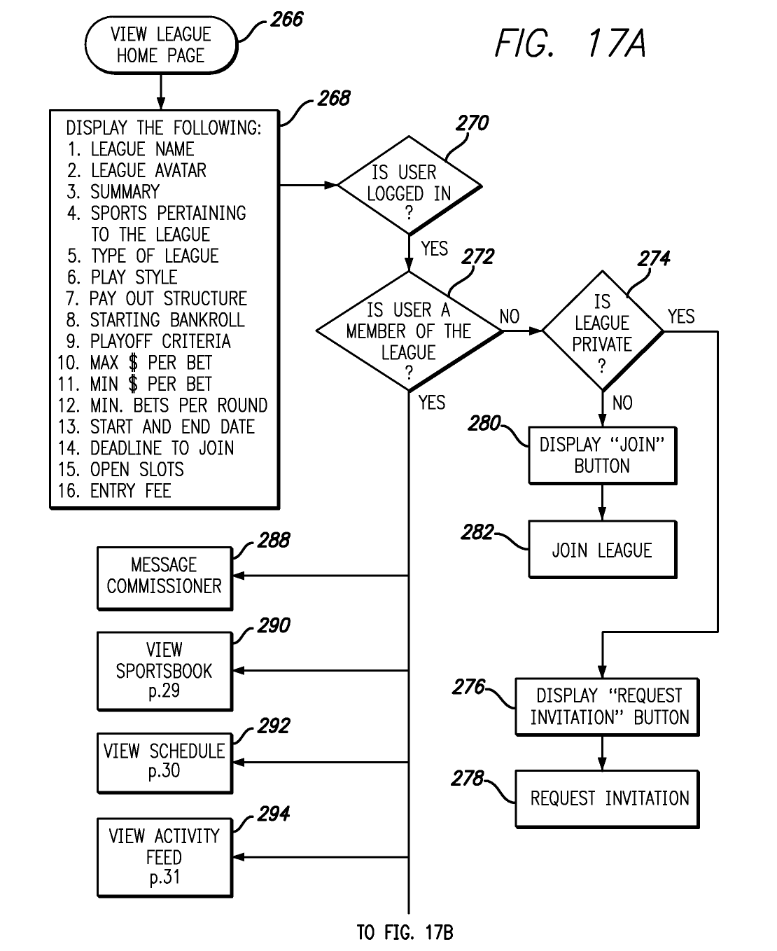

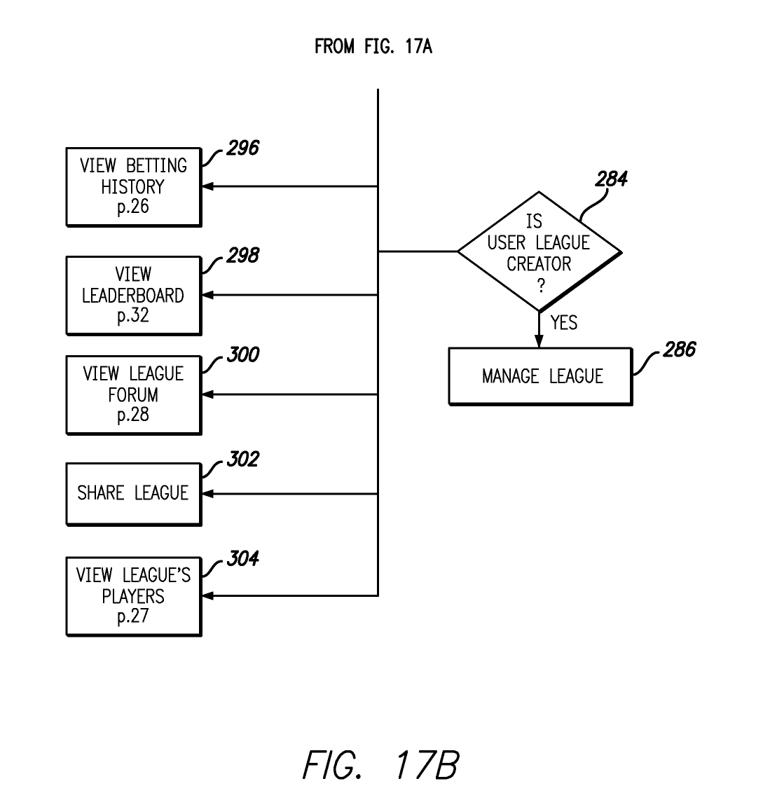

If the user elects to go to a league home page as indicated at 262 in FIG. 16, then the user will be directed to the home page of that league and an algorithm as illustrated in the flow chart of FIG. 17 will be displayed and to which reference is hereby made. As is therein shown, when view the league home page is clicked as shown at 266 there will be displayed to the user the league name, the league avatar if there is one, a summary of the league, the sports pertaining to the league, the type of league, the play style of the league, the payout structure, the starting bank roll, the play off criteria, assuming a playoff in fact has been established when the league is created, the maximum amount of league dollars which may be used on any particular wager and if there is established a minimum amount of league dollars that is required for a wager. There will also be indicated the minimum number of wagers per round, the start and ending dates for a league, the deadline to join, the number of open positions available for that particular league and the entry fee in fantasy gold coins which will be required to join the league. A query will be made to determine whether or not the user is logged in as shown at 270. If the answer is yes, then the query will be made as shown at 272 whether or not the user is a member of the league, that is has the user joined that particular league and paid the entry fee as required. If the answer is no, then the query is made as to whether or not the league is private as is shown at 274. If the league is private and since the user is not a member of the league there will be displayed for the user a request invitation button as shown at 276. The player may then click on that button and the request invitation will be forwarded to the creator of the league as shown at 278 and the creator of the league may issue an invitation to join the league. If the answer to the query whether the league is private or not, is no then there will be displayed a join button shown at 280 which the user may click on. This will then allow the user to join the league as shown at 282.

If the user is a member of the league and thus the query as shown at 272 is answered in the affirmative then the query is made as to whether or not the user is the one who has created this league as is shown at 284. If the answer to that query is yes, then the user is instructed to manage the league as is shown at 286.

If the user is a member of the league and when that query as indicated as shown at 272 is answered in the affirmative then the user is given a number of options that maybe elected. As shown at 288 the user may send a message to the commissioner of that particular league, the user may view the sports book for that particular league as shown at 290, the user may also view the schedule for that league as shown at 292 the user may view the activity feed for that particular league as shown at 294, the betting history of the particular league can also be displayed as shown at 296, the leader board for that particular league may also be displayed as shown at 298, the forum for that particular league may also be viewed as shown at 300, the league may also be shared at shown at 302 and the leagues players may be listed and viewed as shown at 304.

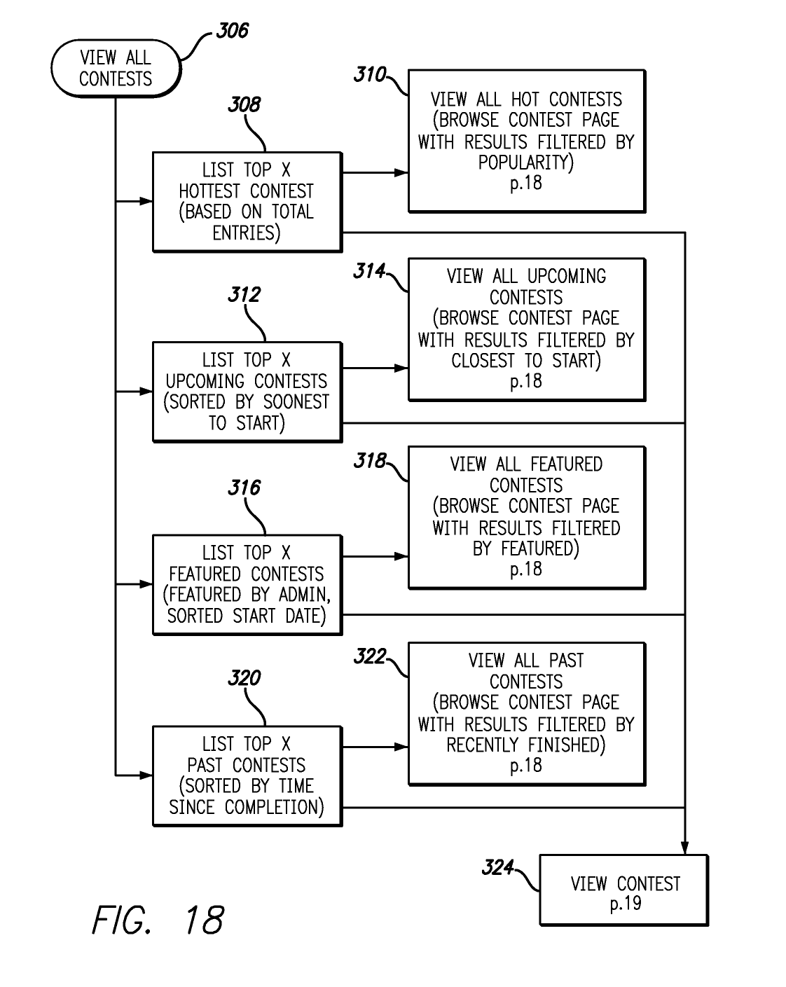

When the user comes to the site, whether logged in or not, the user will be given an opportunity to view all contests as shown at 46 in FIG. 2. If the user clicks onto the view all contests he will be directed to the algorithm represented by the flow chart as shown in FIG. 18 to which reference is hereby made. As is shown in FIG. 18, when a view all contests is clicked on as shown at 306 a number of listings may occur. For example, as shown at 308 there will be a list of a predetermined number of the hottest contests based upon the total entries. If desired the user may also have a listing of all of the hottest contests with the contest page browsed with the results filtered by popularity as shown at 310. Also, there may be listed as shown at 312 a predetermined number of the top upcoming contest which are sorted according to those which are the soonest to start. The user may also have listed all of the upcoming contests irrespective of when they are to start as shown at 314. However, this may be also filtered by the closest to start as illustrated. There may also be listed as shown at 316 a predetermined number of the top featured contests, these are featured by the administrator and sorted according to the start date. All featured contests may be viewed as shown at 318 if desired. As is also shown at 320 there will be listed a predetermined number of the top past contests sorted by time since completion. All of the past contests may also be listed shown at 322. When any of the contests are listed in accordance with the criteria above described with regard to listings as shown at 308 through 322, the user may click onto a specific contest out of those that are listed and when such occurs the view contest as shown at 324 will provide access to that particular contest and will provide detailed information to the user accordingly.

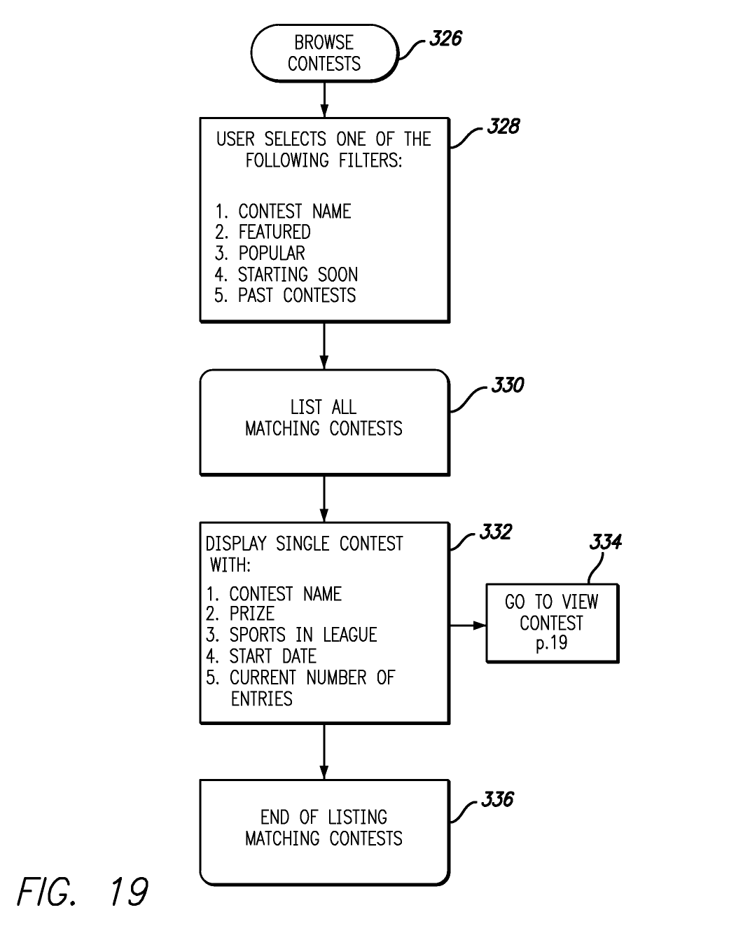

As indicated at 310 through 322 of FIG. 18, the user may like to browse the contest page for the hot contest, upcoming contest, featured contest or past contest according to certain filters that have been applied. If the user elects to browse the contest as indicated and clicks onto that particular feature then the user will be directed to the algorithm as illustrated by the flow chart as illustrated in FIG. 19 to which reference is hereby made. As shown on FIG. 19, when the browse contest 326 is clicked on the user will be provided a number of filters which can be selected by the user. Those filters would be the contest name, the featured contest, the popular contest, those contests which are starting soon or those contests which have already been completed and are now past contests. When the user selects one or more particular filter then the contests will be listed according to the filter or filters selected and that is illustrated at 330. When these contests are listed the user may elect to obtain more information with respect to anyone of the listed contests and will click onto that particular contest. When such is done the contest will be displayed as shown at 332 and will provide to the user the contest name, the prize set forth for that particular contest, the sports which are in that contest or league, the start date and the current number of entries. If desired the player may then go to view that particular contest as shown at 334. Subsequently, there will be a termination of the listing of matching contests as shown at 336.

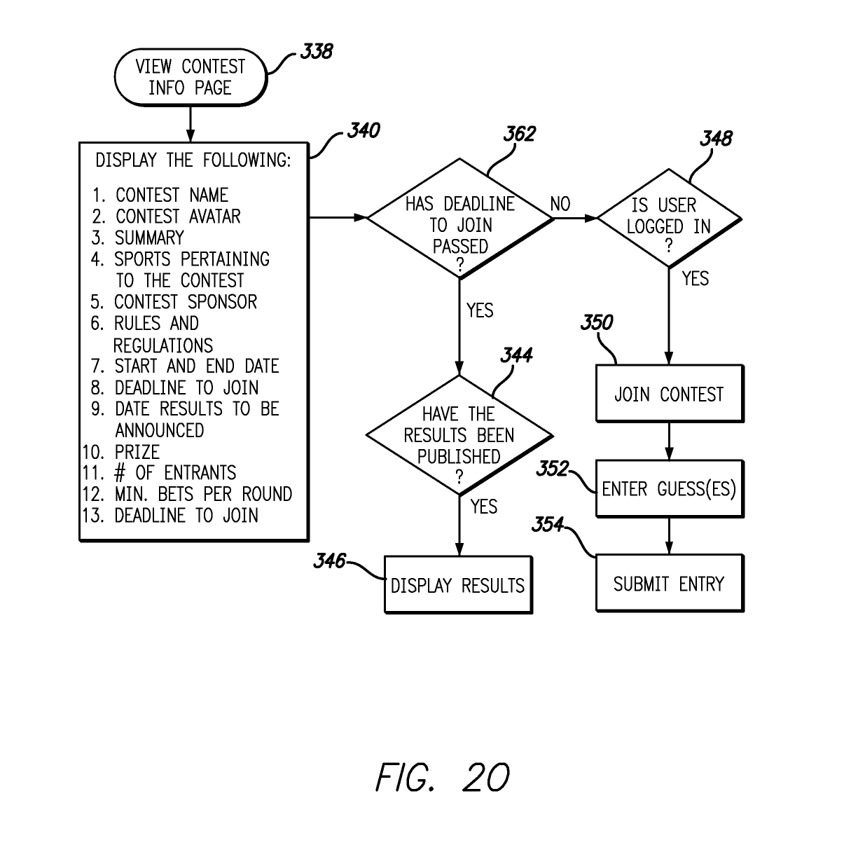

If the user elects to go to view the contest as shown at 334 in FIG. 19, then the user will be directed to the flow chart as shown at FIG. 20 which shows an algorithm to which reference is hereby made. As is therein shown, the view contest information page 338 is clicked on and when such occurs as shown at 340 there would be displayed information concerning that particular contest. The information displayed would be the contest name, the contest avatar if there is one, a summary of the contest, the sports pertaining to the particular contest if any, who the contest sponsor is, any rules and regulations which are in existence with regard to that particular contest, the starting and ending dates for the contest, the deadline to join the contest, the date upon which the results of the contest are to be announced, the prize which would be awarded to the winner of the contest, the number of entrants in the contest, the minimum number of bets per round and the deadline to join. There would be an inquiry as shown at 342 as to whether or not the deadline to join the particular contest has passed. If the answer to that is yes then the query would be indicated as to whether or not the results of that contest had been published as shown at 344 and if in fact they have then the request for displaying the results of the contest may be obtained as shown at 346. If the deadline to join has not passed then the query would be made as to whether or not the user is logged in and if the answer to that is yes then the user would be given an opportunity to join the contest at shown at 350. The user upon joining the contest would then be given the opportunity to enter the contest as shown at 352 and would be able to submit the entry at shown at 354.

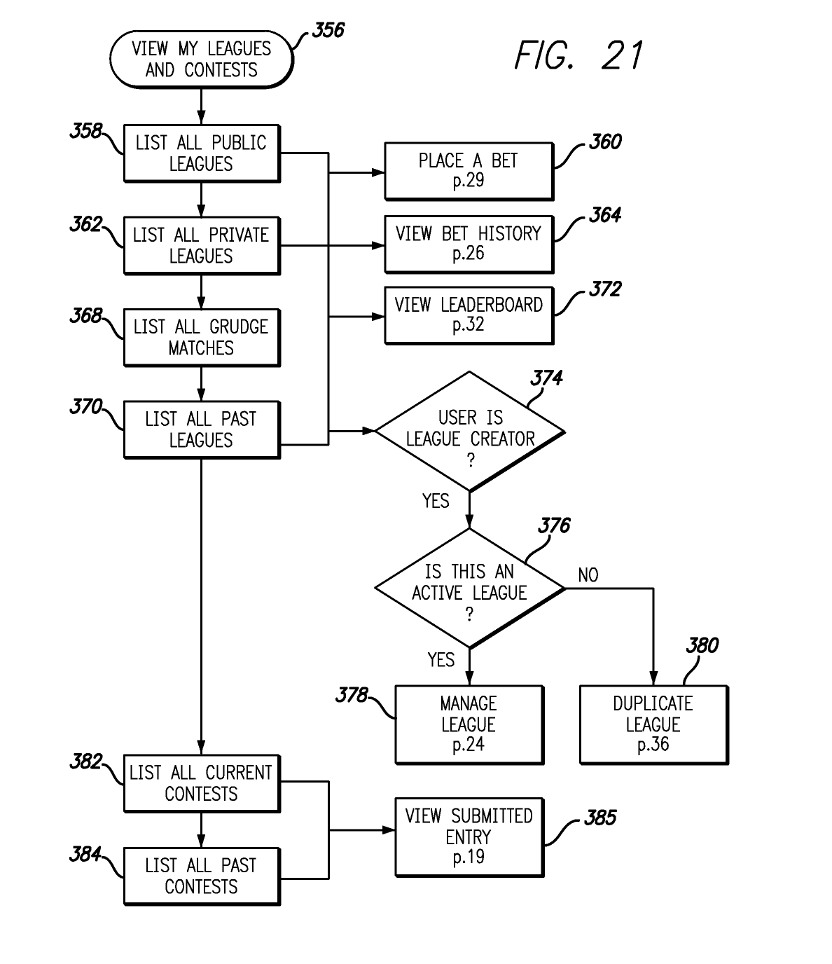

As was discussed in reference to FIG. 2, the logged in user will have an opportunity to view my leagues and contests as shown at 70. If the user elects to view my leagues and contest which are applicable to that particular user then he would be directed to FIG. 21 to which reference is hereby made. FIG. 21 represents an exemplary algorithm enabling the user to view all of the leagues and contests to which the user has subscribed. As is therein shown the view my leagues and contests 356 when active will list all of the public leagues as shown at 358 to which the user has joined. The user will also be directed to place a bet if the user decides to do so as shown at 360. If the user decides to place a bet the user would click onto that particular public league in which the user desires to make a wager or bet.

In addition to the public leagues all of the private leagues which the user has joined will be listed as shown 362. When these leagues are listed the user will be given the opportunity to view the bet history as shown at 364. The bet history when viewed will be with respect to anyone of the private leagues that the user selects.

All of the grudge matches to which the user has subscribed will also be listed as shown at 368. In addition thereto, all of the past leagues which the user has been a member of would be listed as shown at 370. The user will also be given the opportunity to view the leader board as shown at 372. The leader board would be for any particular public league, grudge match or past league that the user has been a member of and is selected by the user. The query would also be made as is shown at 374 as to whether or not the user is a league creator. If the answer to that query is yes, then the query is set forth as to whether or not this is an active league as shown at 376. If the league is active then the user is directed to manage the league as shown at 378. If the answer is no, then the user is given an opportunity to duplicate the league, that is the user would be given the opportunity to again create a league, if the user desires to do so.

Thereafter, all of the current contests which the user has joined would be listed as shown at 382 and all of the past contests would be shown at 384. In addition as shown at 385 the user would have an opportunity to view any entry which has been submitted with regard to a particular contest whether current or past that the user would select.

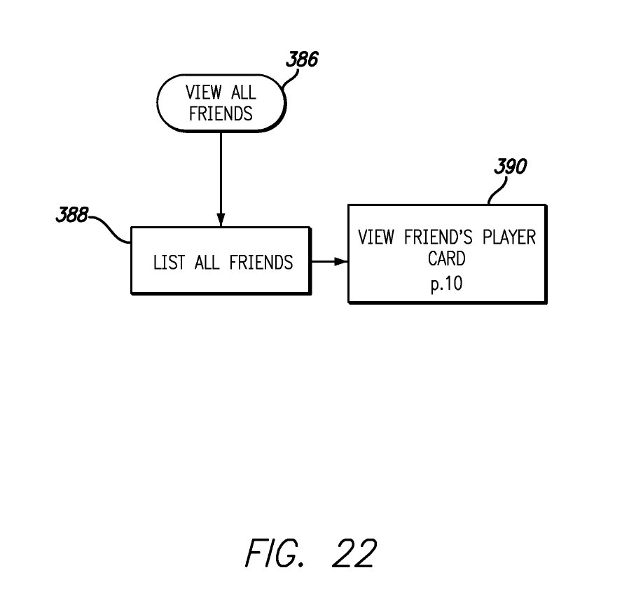

As illustrated in FIG. 2, the user who has logged in would be given an opportunity to view all friends as shown at 74. If such is selected by the user then the user would be directed to FIG. 22 to which reference is hereby made. As is shown in 22, there is an algorithm which enables the user to view all friends as shown at 386. If that is selected then all of the friends of that particular user are listed as is shown at 388. If desired the use may select a specific one of the friends that appear on the list and would have an opportunity to view that friends player card as shown at 390.

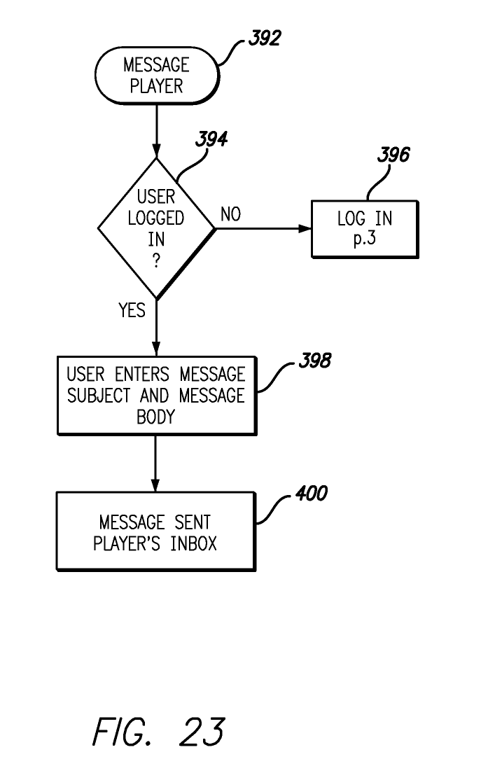

As discussed and illustrated with regard to FIG. 11, when a players card is being viewed by a user the user would have an opportunity to construct a message and send it to that player as shown at 202. If such is desired then the logged on user would be directed to FIG. 23 to which reference is hereby made. As is illustrated in FIG. 23, an algorithm is provided which enables the user to message the player as shown at 392. If such is selected then the query is generated as to whether or not the user is logged in as shown at 394. If the answer to that query is in the negative then the user is directed to log in as shown at 396. If on the other hand the user is logged in then the answer to that query of whether or not the users logged is in the affirmative and the user would be directed to generate a message as shown at 392. The user would enter a subject followed by the narrative of the body of the message. Once the user is satisfied with the subject and the body of the message then the user would send that message to the players inbox as shown at 400 who's player card the user is viewing.

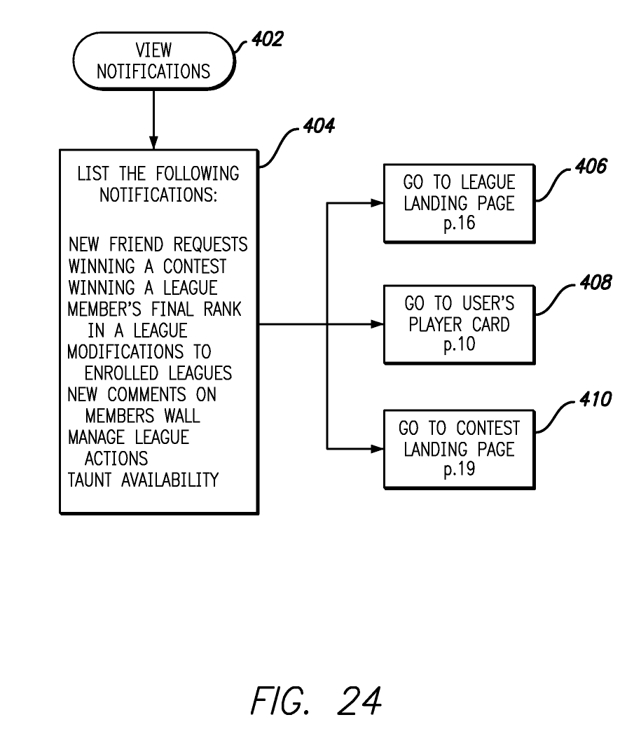

Again as discussed and illustrated with respect to FIG. 2, the user who is logged in would be given an opportunity to view all the notifications which are pertinent to that particular user as shown at 72. If the user elects to view his notifications then he would be directed to FIG. 24 to which reference is hereby made. FIG. 24 provides an exemplary algorithm allowing the user to view all of the notifications that are applicable to that particular user as is shown at 402. If the user clicks onto this then the listing of the notifications as shown at 404 would be displayed. The type of notifications which are displayed would be new friend requests, winning a contest, winning a league, members final rank in a league, modifications to leagues in which the user is enrolled whether those leagues be public or private, new comments which have been entered onto that member's wall, any managing activities with regard to a league which the user has created and the taunt availability. Once these notifications are listed the user would have an opportunity to go to a league landing page as shown at 406 or go to a user's player card as shown at 408 or go a contest landing page as shown at 410.

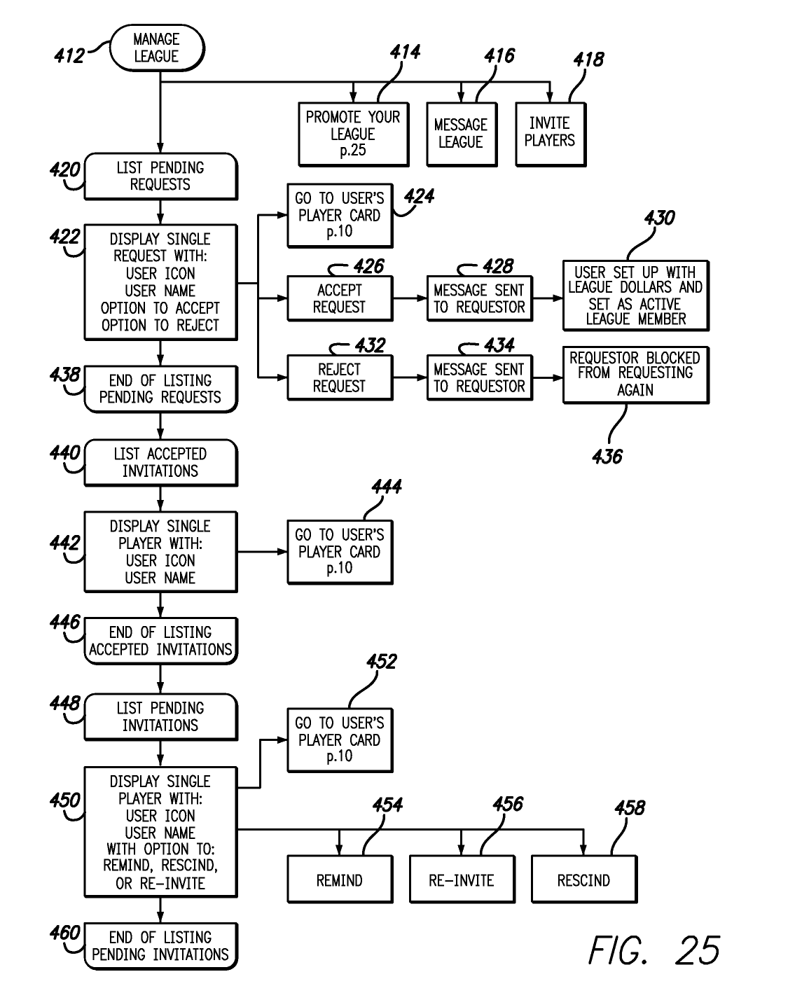

As indicated in conjunction with the discussion of FIG. 21, when a player is viewing his league or contest he would be given a direction to manage a league as shown 378 on FIG. 21. If the user elects to manage a league then the user would be directed to FIG. 25 to which reference is hereby made. As is therein shown, there is provided an exemplary algorithm which would enable the user to manage the league which the user has created as shown at 412. In managing the league the user would be given the opportunity to promote the league as shown at 414 or to provide messages which would be transmitted to all of those who have joined the league as shown at 416. In addition thereto, the user who has created the league would be given the opportunity to invite other registered users or players to join the league as shown at 418.

In the event that the league which has been created by the user is to manage is a private league there may be a number of requests to join the league which are pending and need to be acted upon and those pending requests would be listed as shown at 420. The user would then have an opportunity to click onto to any of those pending requests that are listed and if such is done then it would be displayed as a single request as shown at 422. That single request would provide the user with the user name and icon of the one who is requesting to join the league and would provide an option to the user who is managing the league to either accept or reject the request to join the league. When the single request is listed the user who is managing the league may desire to obtain additional information with regard to that user before making a decision as to whether to exercise the option to accept or reject. Under those circumstances the user would go to that user's player card as shown at 424. Once the user has then satisfied the need for additional information that is available on the players user's card the user would then decide whether to accept or reject the request. If the user decides to accept the request as shown at 426 then the user would generate a message as shown at 428 which would be sent to the user whose pending request is now being viewed and acted upon. Once the message is sent to the requestor that he has been accepted to join the league, then that individual would be provided with fantasy league dollars as shown at 430 and would be set as an active member of that particular league. On the other hand, if the user has decided to reject the request as shown at 432 then the message would be generated and sent to the individual who's single request has been selected to that affect as shown at 434 and that requestor would be blocked from requesting to join this particular league again as shown at 436. Subsequently, there would be a termination of the listing of pending requests as shown at 438.

In addition to the forgoing all of the accepted invitations to join that league would be listed as shown at 440. The user may then display a single player who has been accepted as shown at 442. When this is done that would provide the user who is managing the league with the name and icon of the single player who has been selected. The user managing league may also desire to get additional information that would then go to that user's player card as shown at 444. Subsequently, there would be a termination of the listing of the accepted invitations as shown at 446. Also, would be listed all of the pending invitations at shown at 448. Again the user managing the league may decide to select a particular single player as shown at 450. When this is done that player would be identified by the players name and icon and the user managing the league would be given an option to remind that player that there is a pending invitation and such is shown at 454. The player may also be re-invited as is shown at 456 or on the other hand the one managing the league may decide to recind the invitation because it has not been accepted at this point and time. Before making the decision as to whether to remind, re-invite or recind, the user managing the league may wish to get additional information with regard to that single player, and, if such done, he would go to that user's player card as shown at 452. Subsequently, there would be a termination of the listing of all of the pending invitations as is shown at 460.

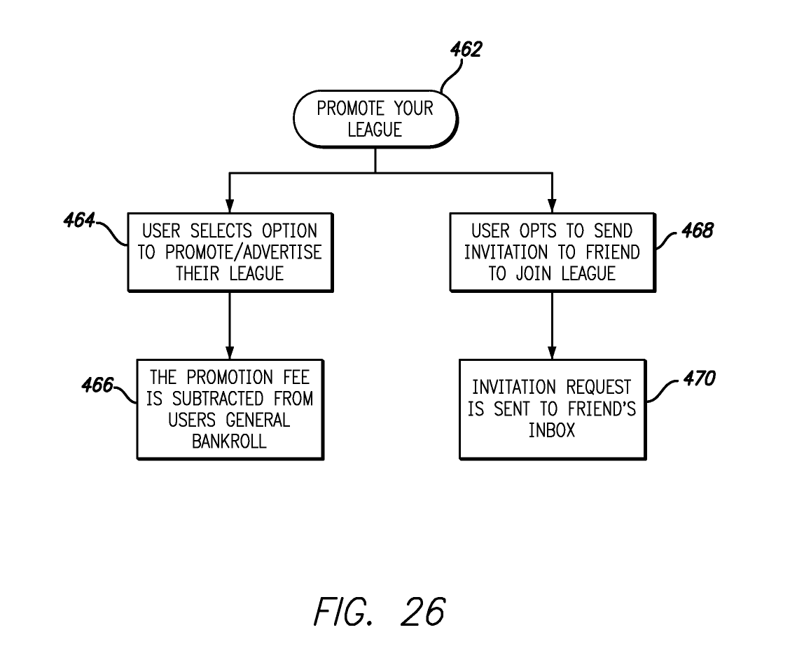

As noted above, in the discussion with regard to FIG. 25, the creator of a league may have the opportunity to promote the league as shown at 414. When the user who has created the league clicks on to promote your league it will be directed to FIG. 26 which provides an exemplary algorithm to which reference is hereby made. As is therein shown, the promote your league 462 provides an option to promote or advertise the league as shown at 464. If the user elects to promote or advertise the league then the promotion fee is subtracted from the users general fantasy gold coin bank roll as shown at 466. The user may also have the option to send an invitation to a friend to join the league as is shown at 468. If such is done then the user generates the invitation and forwards it to that friend's inbox as shown at 470.

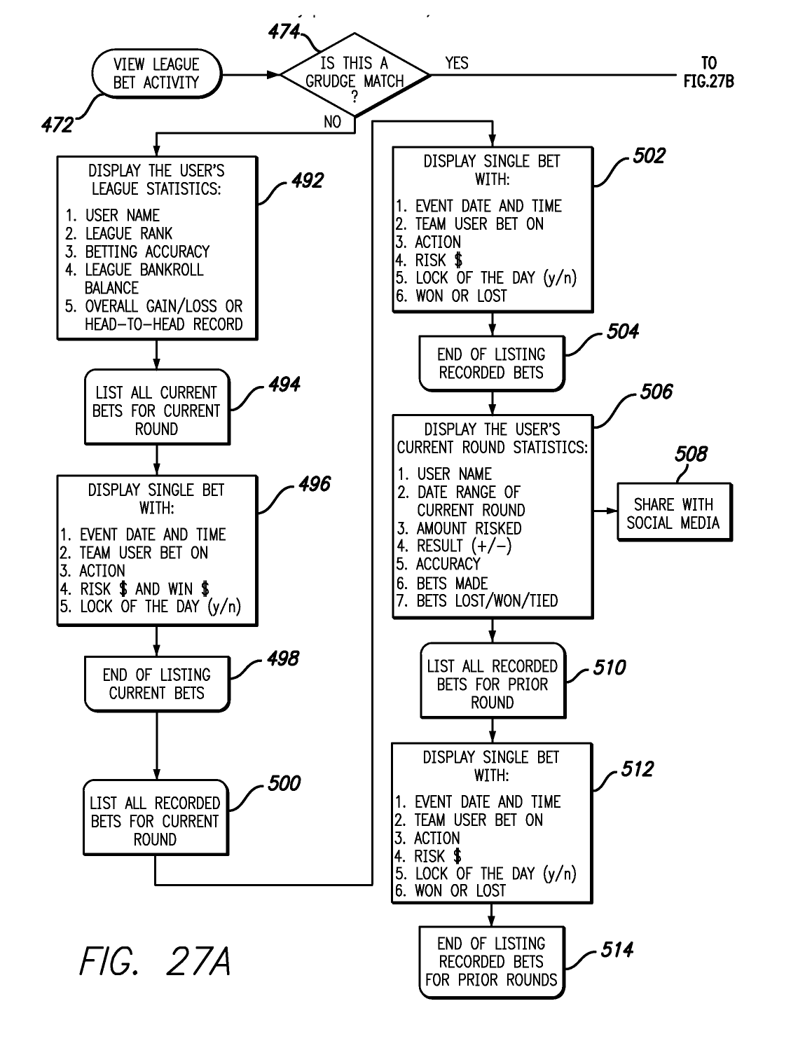

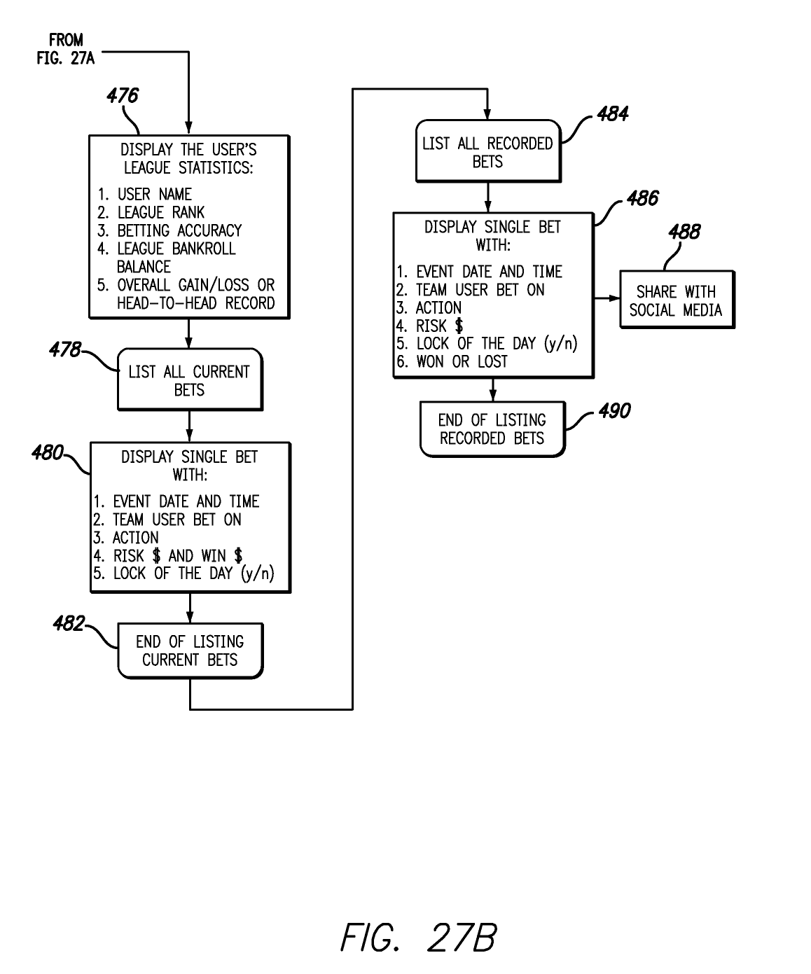

As is indicated in the discussion with regard to FIG. 21, when a user is viewing his or her league and contest there will be the opportunity to view the bet history for the league as shown at 364 and this will refer the user to FIG. 27 to which reference is hereby made. As is shown in FIG. 27 there is represented an algorithm which will provide the user with the wagering activity with regard to the specific league which is of interest and such is shown at 472. The first query that is made is whether or not this is a grudge match as shown at 274. If the answer to that query is in the affirmative, then the user's league statistics will be displayed as shown at 476. This will include the user's name, the rank of the user in the league, the accuracy of the wagers which have been placed by the user, the balance of the league dollars bank roll for that particular user and the overall gain or loss of any head-to-head record. As is shown at 478 all of the current wagers which are in existence by that user in that league will be displayed. The user may then click onto any specific wager and as shown at 480 that wager will be displayed along with the event date and time, the team user bet on the action, the risk amount and the win amount, and the lock of the day. Subsequently, there will be a termination of the listing of the current bets as is shown at 482. There will also be a list of all recorded bets as shown at 484. The user may then click on to any specific recorded bet for which additional information is desired as is shown at 486 and that individual bet or wager will be displayed along with the event date and time, the team user bet on, the action, the amount of league fantasy dollars at risk, the lock of the day and whether the wager was won or lost. If desired the information displayed with regard to that single bet may be shared by the user with the friends on the social media as shown at 488. The user may also provide a direction to the league that the results of the wager that has been placed may be automatically shared with the users friends on his social media network. If such is done, then the user will be issued additional league dollars, which the user may then use for additional wagers. Subsequently, there will be a termination of the listing of the recorded bets as shown at 490.

If the answer to whether this is a grudge match or not is answered in the negative then as shown at 492 the users league statistics will be displayed including the users name, the league rank, the betting accuracy, the balance of the fantasy league dollars in the bank roll, the overall gain or loss or a head-to-head record. There will then be a listing of all current bets for the current round as shown at 494. If desired the user may click on any one of the current bets for the current round and that particular bet will be displayed as shown at 496 along with an event date and time, the team user bet on, the action, the amount of league fantasy dollars and the risk and/or possible win and the lock of the day. Subsequently, there will be a termination of the listing of the current bets as is shown at 498. There will then be a listing of all the recorded bets for the current round as shown at 500. The user may then click on any one of the recorded bets for the current round and that particular bet will be displayed as shown at 502 along with the event date and time, the team user bet on the action, the amount of league fantasy dollars risk, the lock of the day and whether the wager was won or lost. Subsequently, there will be a termination of the listing of the recorded bets as is shown at 504. Thereafter, there will be displayed the users current round of statistics as shown at 506 which will include the user's name, the date range of the current round, the amount risked, the result, that is, won or lost, the accuracy of the bets made and the bets lost, won or tied. Again, the user may desire to share this with his friends listed in the social media which may be done as shown at 508 and if such is done the user will be issued additional league dollars. There may also be a list of all recorded bets for all prior rounds as shown at 510. Again, the user may desire to determine information with regard to a single one of the prior round recorded bets, and, if such is desired then the user would click onto that particular bet. That bet will then be displayed as shown at 512 along with the event time and date, the team user bet on the action, the amount of league fantasy dollars at risk, the lock of the day and whether the bet was won or lost. Subsequently, there will be a termination of the listing of the recorded bets for the prior rounds as shown at 514.

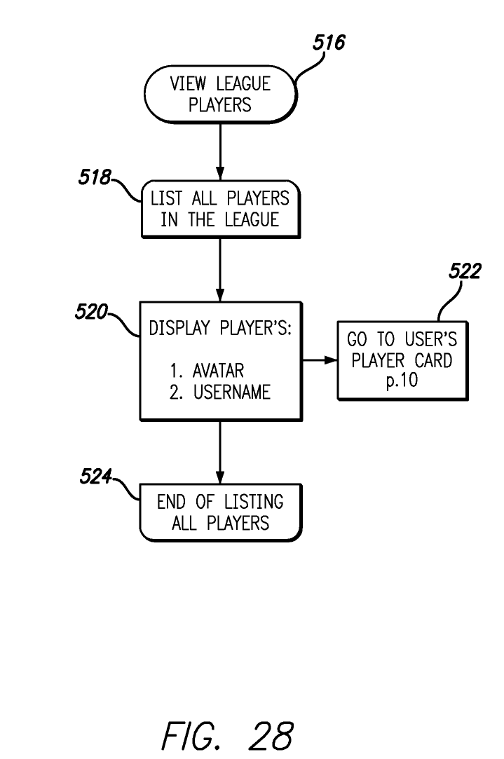

As discussed in conjunction with FIG. 17, when a user is logged in with regard to viewing a particular league home page, one of the options will be for the user to view all of the players who have joined that league, as is shown at 304 in FIG. 17. If the user desires to do this and clicks onto that option then the user will be directed to the algorithm as shown in FIG. 28 to which reference is hereby made. As is illustrated in FIG. 28, the selection of the view the league players as shown at 516 will generate a list of all the players who have joined that particular league at 518. If the user wishes to obtain additional information with regard to any one of the specific players listed then the user may click onto that particular player and there will be displayed the user name and the avatar, if there is one for that player as shown at 520. If additional information is desired with regard to that particular player then the user may go to the user's player card as shown at 522 to provide such additional detailed information. Subsequently, there will be a termination of the listing of all the players in the specific league as shown at 524.

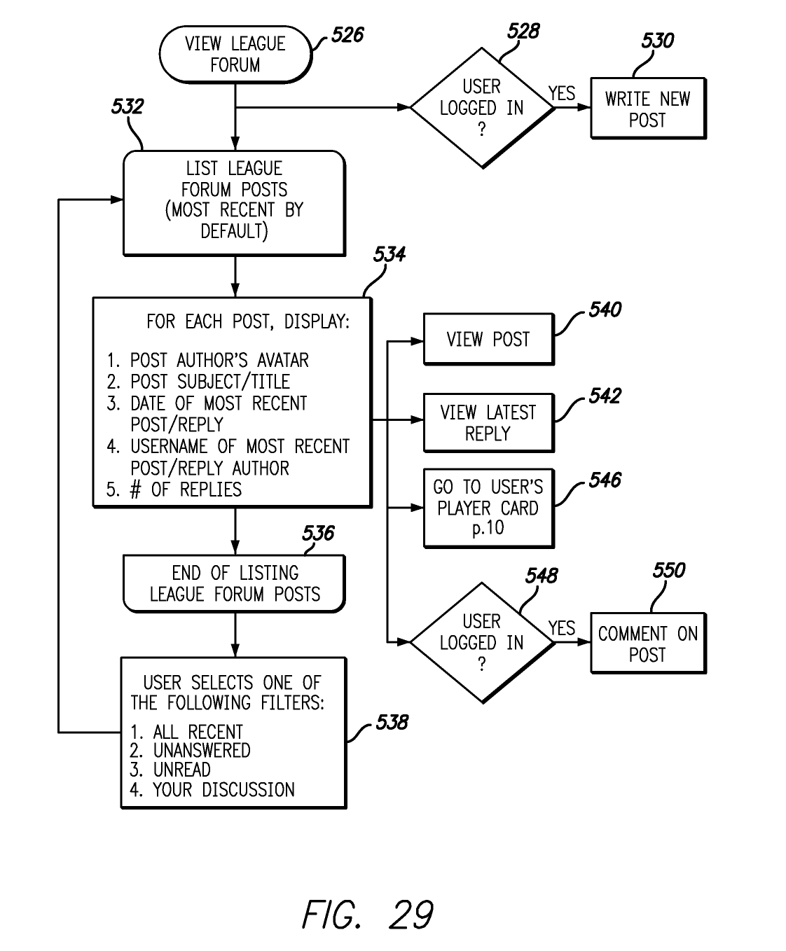

As also discussed in conjunction with FIG. 17, the user when logged on may also have the opportunity to view the forum for the specific league involved as is indicated at 300. If the user does decide to go to the league forum then the algorithm as shown at FIG. 29 will be utilized. As is therein shown the view league forum is clicked on as shown at 526. The query is made as to whether or not the user is logged in as is shown at 528. If the answer to that is in the affirmative then the user will be given the opportunity to write a new post as shown at 530 which then can then be entered into the forum. As is shown at 532, all of the forum posts will be listed for the specific league and these posts will be listed with the most recent being first. Once those posts are reviewed the user may decide to click on a specific post and when such is done there will be displayed particular information with regard to the post shown at 534. That information will include the author's avatar, if available, the subject or title of the post, the date of the most recent post or reply, the user name of the most recent posts or reply and the number of replies to that forum. Subsequently, there will be a termination of the listing of all the league forum posts as is shown at 536. As is shown at 538, the user may select filters which will be utilized in the listing of the league forum post and such filters will be all of the recent posts, those that have been unanswered, those that have been unread and the discussion by the user.

In addition to the foregoing when the posts are displayed as shown at 534 the user will have an opportunity to view the post as shown at 540, to view the latest reply to the post as shown at 542, to go to the users player card as shown at 546, that is, the player who has generated a particular post and with regard to which the user may wish to obtain additional information, the query will also be made to whether or not the user is logged in as shown at 548 and if the answer to that is in the affirmative then the user will be able to comment on the post as shown at 550.

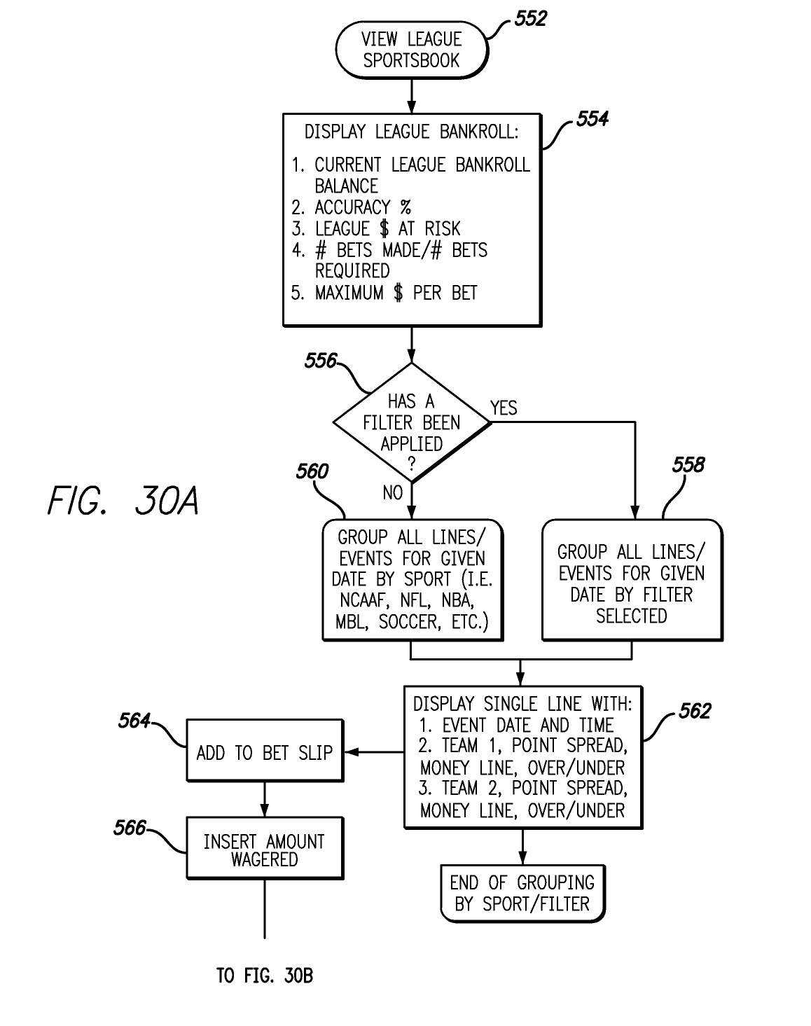

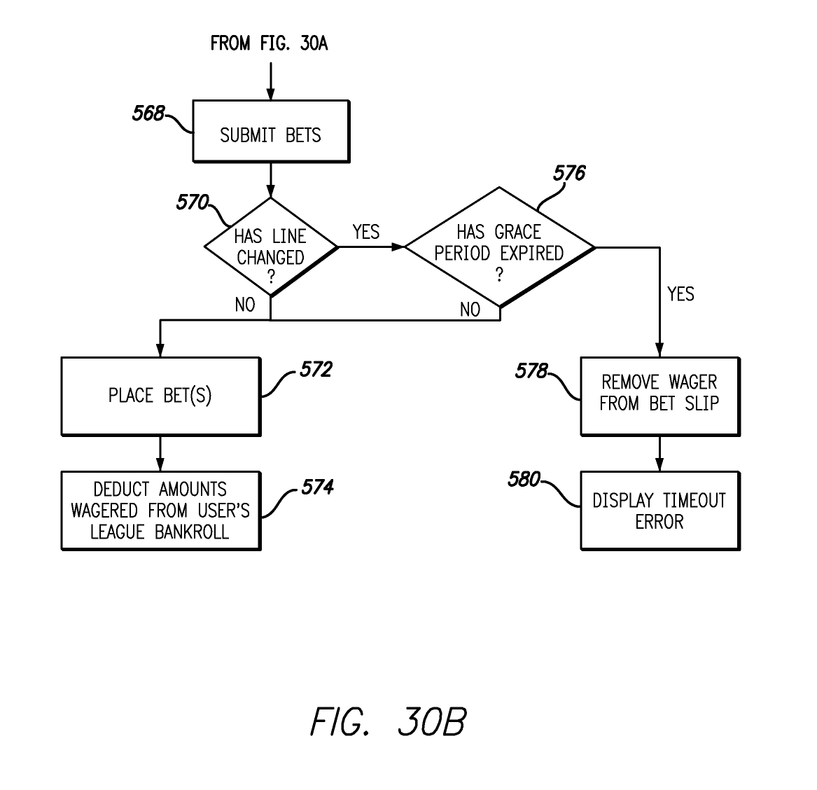

As also discussed in conjunction with FIG. 17, when viewing the league home page the user may have an opportunity to view the leagues sports book as is shown at 290. If such is desired the user would be directed to FIG. 30 where there is an algorithm which enables viewing a leagues sports book at shown at 552. When this is selected the bank roll of the league is displayed at shown at 554, this would include the balance of the leagues current bank roll of fantasy gold coins, the accuracy percent, the league dollars at risk, the number of bets made and the number of bets required and the maximum dollars per bet. As is shown at 556, the query would be made as to whether or not a filter has been applied that would have an effect on displaying the information concerning of the leagues sports book as is shown at 556. If the answer to that query is in the affirmative then as shown at 558 there would be a grouping of all the lines/events for the given date by the filter which has been selected. If the answer to that query is in the negative then all of the line or events for the given date by the sport would be grouped as shown at 560. As is shown at 562 the user may wish to obtain information with regard to a single line and if that is clicked on such would be displayed with the event date and time, the team one point spread, money line, over/under and the team two point spread, money line and over/under. The user may then add a wager as shown at 564 and if this is selected then the amount to be wagered would be inserted as shown at 566 and would be submitted as shown at 568. The query would then be set forth as to whether or not the line has changed as shown at 570. If the answer to that query is in the negative then the user would be directed to place the bet and when that is done the amount wagered by that player would be deducted from that users fantasy league dollar bank roll as shown at 574. If the query to whether or not the line has been changed is answered in the affirmative, then an additional query has to whether or not the grace period within which to wager has expired as shown at 576. If the answer to that is in the negative then the bet can be placed and the amount deducted as shown at 572 and 574. If, however, the grace period has expired and that query is answered in the affirmative then the wager is removed from the bet slip as shown at 578 and there is displayed a time out error at shown at 580.

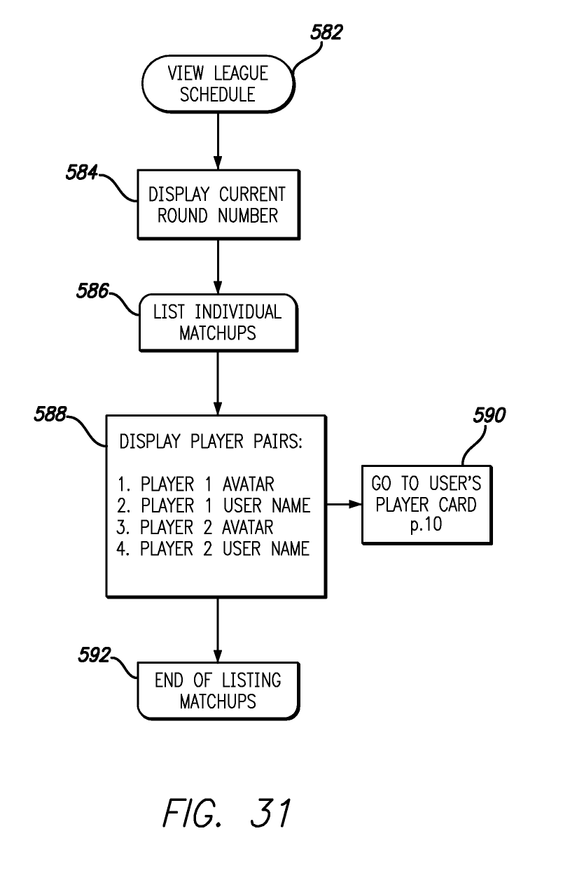

Again in conjunction with the discussion of FIG. 17, the player who has been logged in may be given the opportunity to view the schedule of the particular league home page which is being viewed, such as is shown at 292 in FIG. 17. If the user elects this then the user will be directed to FIG. 31 to which reference is hereby made. FIG. 31 displays an algorithm which will allow the user to view the leagues schedule as shown at 582. The current round number will be displayed as shown at 584 and the individual match ups will be displayed at 586. The player pairs will be displayed as shown at 588 which will include the first players avatar and user name and the second player's avatar and user name, and if desired the user may go to view the user's player card as shown at 590. Subsequently, there will be a termination of the listing the match ups as shown at 592.

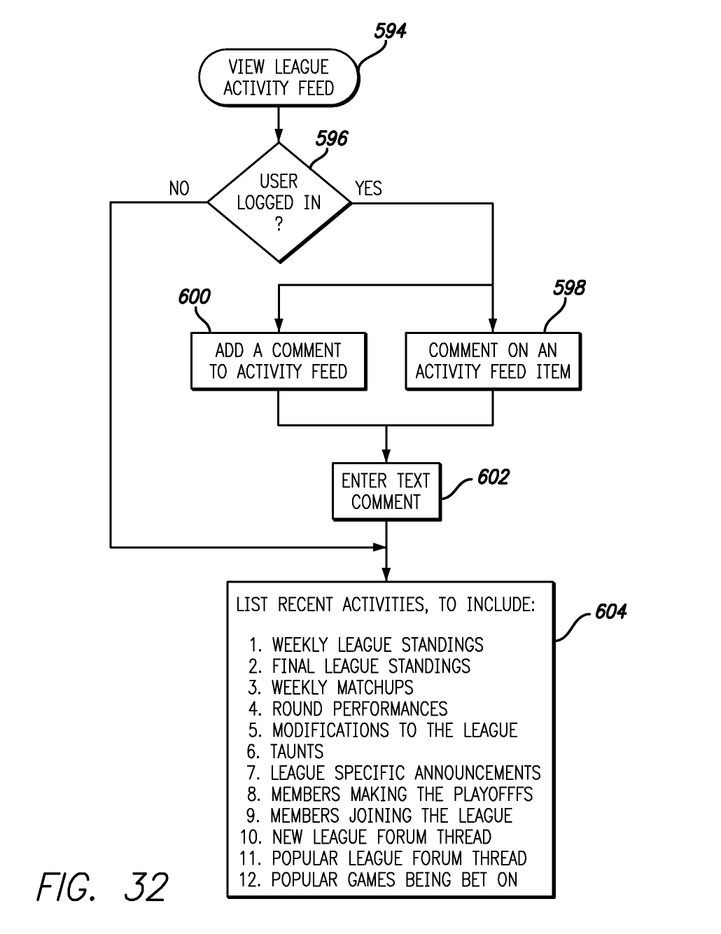

Again with respect to FIG. 17, the user who is viewing the league home page would have an opportunity to view the activity feed which is germane to that particular league as is shown at 294 in FIG. 17. If the user does elect to view that leagues activity feed then the user would be directed to FIG. 32 to which reference is hereby made. As is shown in FIG. 32, there is displayed an algorithm which would allow the user to view the specific leagues activity feed as shown at 594. The user would be queried as to whether or not the user is logged in as is shown at 596. If the answer to that query is in the affirmative then the user would be given an opportunity to comment on an activity feed item as shown at 598 or alternatively as shown at 600 the user would be given an opportunity to add a comment to the activity feed as that user may desire. In either event the user would generate a narrative text which would be in the form of a comment on an existing activity feed item or would be to generate a new comment which would be directed toward the activity feed. In either event the text as generated would be entered as shown at 602. If the user is not logged in or after the text has been entered there would be a listing of all the recent activities as shown at 604 and this would include the weekly league standings, the final league standings, the weekly match ups, the round performances, the modifications to the league, taunts that may have been issued, leagues specific announcements, the listing of the members making the playoffs, the listing of the members joining the league, a new league forum thread, the popular league forum threads and popular games being bet on.

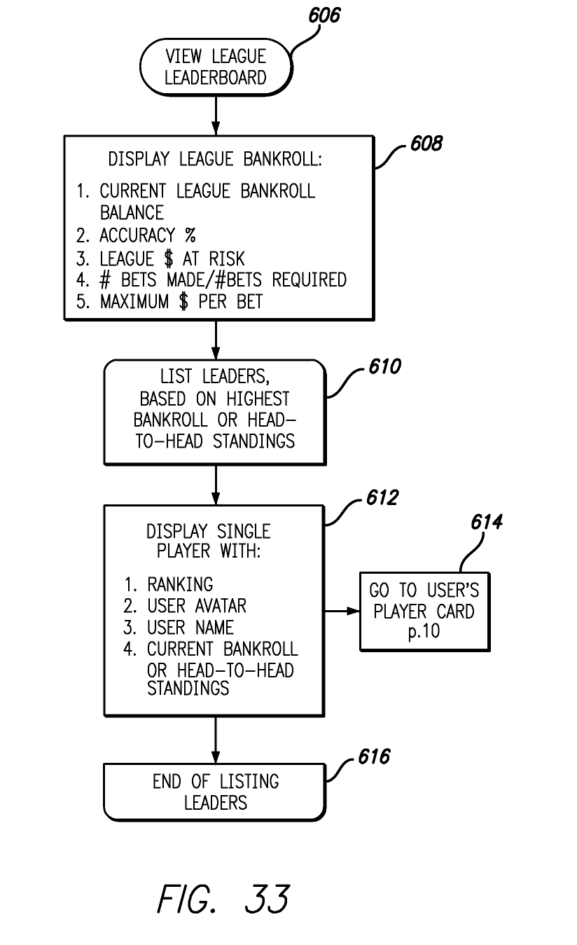

Again in conjunction with the discussion of FIG. 17, if the user is logged on to view a specific league home page he would be given the opportunity to view the leader board that is applicable to that particular league as is shown at 298 in FIG. 17. If the user wishes to view the leader board then the user would be directed to FIG. 33 to which reference is hereby made. FIG. 33 displays an algorithm which would allow the user to view the league leader board of a specific league as shown at 606. If this is desired then at shown 608 the bank roll for that specific league would be displayed and would include the current league bank roll balance in the form of fantasy gold coins, the accuracy percent, the league bank roll at risk, the number of bets made, the number of bets required and the maximum dollars per bet. As shown at 610 there would be a listing of all of the leaders based on the highest bank roll or head-to-head standings. If the user desires, the user may click onto a particular one of the leaders that have been listed and that particular player would be displayed as shown at 612 and would be given the ranking of that player using the name of the player and the avatar of the player if such is available along with the current bank roll or head-to-head standings. Again if desired the user may go to that specific user or player who has been displayed and go to that user's player card as shown at 614. Subsequently, there will be a termination of the listing of the leaders in the league as shown at 616.

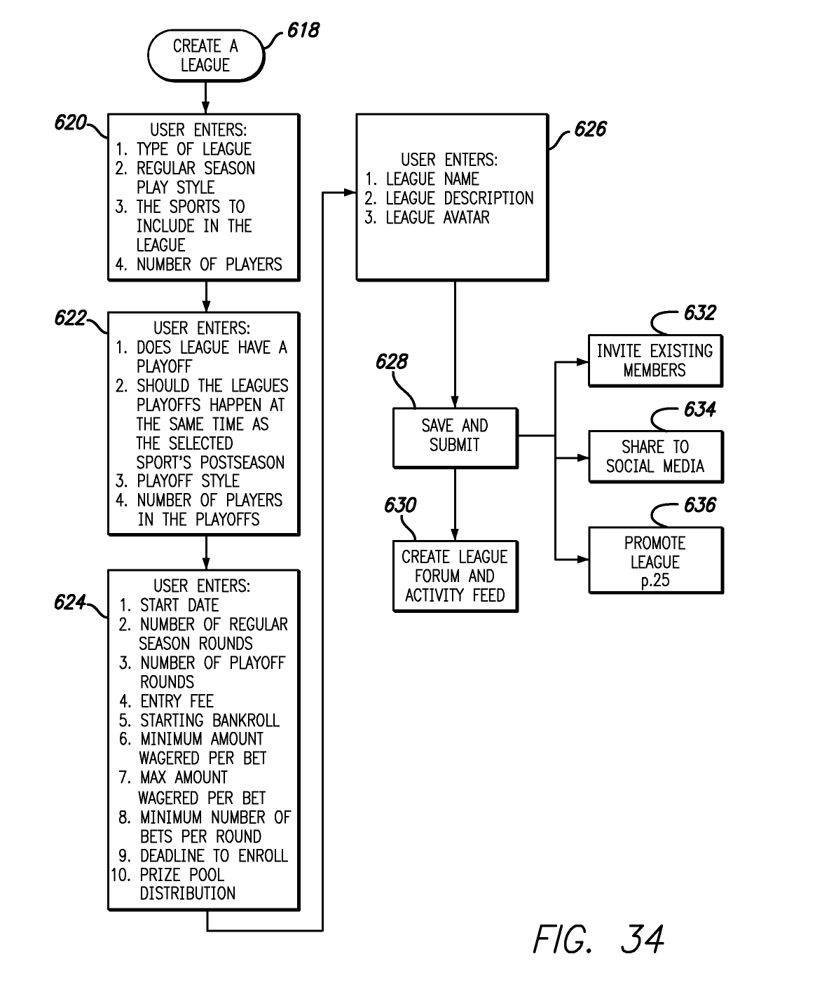

As discussed in conjunction with FIG. 2, once a user has been logged on, the user would be given an opportunity to create a league as shown at 64 in FIG. 2. If that is clicked on the user would then be directed to FIG. 34 to which reference is hereby made. FIG. 34 displays an algorithm which would allow the user to create a league as shown 618. If the user wishes to create a league then as shown at 620 the user would enter the type of league that is to be created, that is, whether the league would be a public league or private league or grudge match. Also, would be entered the regular season, play style, the sports to be included in the league, as well as the number of players. In addition, as shown at 622 the user who is creating the league would have the option of deciding whether the league would have a playoff and that if the playoffs do happen, does this occur at the same time as the selected sports post season or at a different time which does not coincide with the sports post season. The style of playoff would be selected as well as the number of players in the playoffs. Typically the number of players would be dependent upon the ranking of those players who have joined in this specific league. If there is to be a playoff, then as shown at 624, the user creating the league would enter the start date of the playoff, the number of regular season rounds, the number of playoff rounds, the entry fee which is to be charged to the player who wishes to join the league, the starting bank roll in fantasy league dollars which would be given to each player upon joining the league, the minimum amount that can be wagered per bet, the maximum amount that can be wagered per bet, the minimum number of bets per round, the deadline to enroll and the distribution sequence of the prize pool. The user creating the league then enters the league name, the league description and the league avatar as shown at 626. The information that has been entered would then be saved and would be submitted as shown at 628. When this occurs there would be created on the system the particular league, the league forum and the activity feed for that league as shown at 630. The creator of the league would then have an opportunity to invite existing members to join the league as shown at 632 and would also have an opportunity to share the existence of this new league that has been created with the social media that is accessible to the user who is creating the league as shown at 634. In addition, the user creating the league would have an opportunity to promote the league as shown at 636.

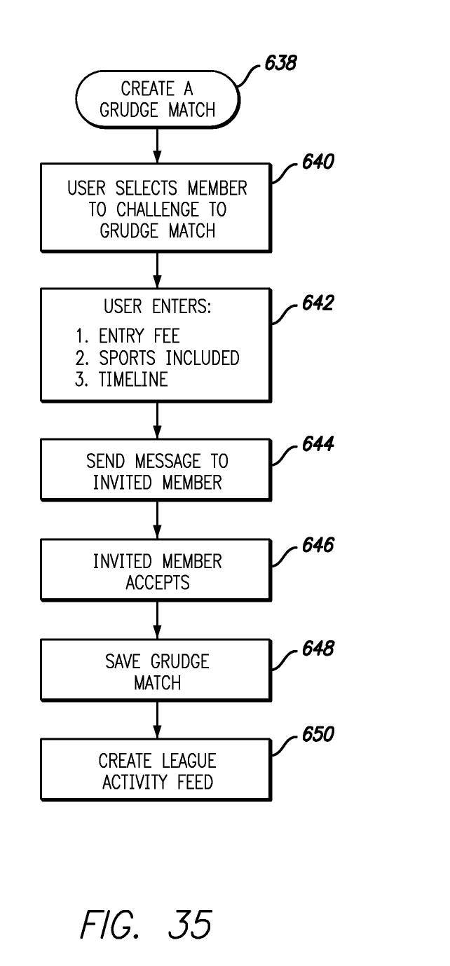

In conjunction with the discussion of FIG. 6, when a user is viewing a players card one of the options provided is for the user to challenge that player whose card is being viewed to a grudge match as is shown at 200 in FIG. 11. If the user does decide to challenge the player to a grudge match then the user would be directed to FIG. 35 to which reference is hereby made. FIG. 35 illustrates an algorithm which permits the user to create a grudge match as is shown at 638. A grudge match is a head-to-head competition between two registered users and is implemented as a private two member league with bracket play. In order for there to be a grudge match created the two members must have placed at least between 151 and 200 wagers each. There would be a link on a user's profile page called grudge match which would only be displayed if the user has in fact placed that minimum number of wagers. When the grudge match link is clicked the system checks to see if the initiating member has in fact placed the minimum number of wagers. If not, a pop up will notify the initiating member that they do not have the minimum number of wagers placed required to initiate a grudge match. If however, the minimum number of wagers have been placed then the user would be allowed to create the grudge match and the following options would be displayed, the entry fee, the sports included, the time line for the grudge match, the length of a round and once this information has been entered then they would click onto create a grudge match as is illustrated at 638 in FIG. 35. The user creating the grudge match selects the member to challenge to the grudge match as above-identified and as shown at 640. As shown at 642 and as above discussed the user enters the entry fee, the maximum amount of which is 15% of the lower balance of fantasy gold coins of the two users who will be involved in the grudge match, the particular sports included as well as the time line. As shown at 644 a message is sent to the invited member and the invited member can accept as shown at 646. If the member accepts then the saved grudge match is clicked as shown at 648 and the system creates the league activity feed as shown at 650. Once the grudge match has been accepted then the system will notify all of the friends of the user as to the existence of the grudge match.

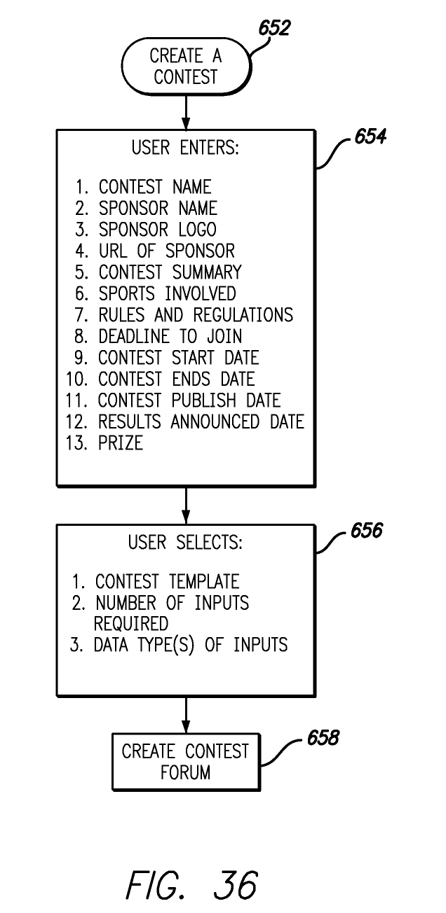

As discussed in conjunction with FIG. 2, if the user is an administrator then the administrator would be given the opportunity to create a contest as shown at 60. If the administrator does desire to create a contest then the algorithm as shown in FIG. 36 would be provided. As is therein shown the administrator may create a contest as shown at 652. If the user administrator does create the contest then the user administrator would enter the contest name, the sponsor's name and logo, as well as the URL of the sponsor. The administrator would also create a summary of the contest and enter that, as well as the sports involved and any rules and regulations that would apply to the contest. There would also be entered a start date and end date for the contest, as well as a deadline by which any users who are interested must join the contest. There would also be entered the date upon which the contest would be published and when the results would be announced as well as what the prize would be to the winner of the contest. As shown at 656, the administrator creating the contest would also be able to enter a contest template, the number of inputs required and the data types of inputs. The system would also create a contest forum as shown at 658.

There has thus been described a method and system in which there can be established a virtual community of registered users who would engage and participate in an interactive fantasy wagering gaming system. The method and system allows interested users to establish public and private leagues which are applicable to any desired sport and may extend for any period of time desired by the user who is creating the league. In addition, contests may be established by an administrator. The private leagues which can be established can be directed to any desired sport and can be for any desired number of registered users to participate in the private league including a head-to-head grudge match between two individual registered users. Upon joining the system a registered user would be issued a predetermined amount of fantasy gold coins which may be utilized to enter leagues. When a user does enter a league, the user is issued a predetermined amount of fantasy league dollars which are useable only in that specific league to place wagers. Each of the users who joins that specific league is issued the same amount of fantasy league dollars. The wagers which are placed by all of those who join a particular league are then tracked to determine the winner of the particular league. If desired there can be established a playoff for a selected number of users who have joined the league and this would typically be determined by their ranking as to the success of the wagers that have been placed.

What is claimed as new and desired to be protected by Letters Patent of the United States is:

1. A method for providing an interactive fantasy wagering gaming system for a plurality of users via a communication network comprising:
1. establishing a virtual community of registered users for participating in said gaming system;
2. providing links to each users social media networks;
3. providing an administrator for said system to create the leagues, and oversee the activity of the users;
4. establishing public and private leagues;
5. issuing a predetermined amount of fantasy gold coins to each user when said user registers;
6. issuing a predetermined amount of fantasy league dollars to a user when said user joins a league, said fantasy league dollars being used only for wagers by said user during the duration of that specific league;
7. enabling each of said users to wager at least a portion of their fantasy league dollars on the outcome of one or more events as identified in said specific league; and
8. tracking the number of wagers made by each user and the outcome of such wagers.

2. A method as defined in claim 1 which further includes the steps of selecting a predetermined number of the most successful users based on the accumulation of said fantasy league dollars during said specific league.

3. A method as defined in claim 1 which further includes the steps of issuing additional fantasy gold coins to registered user when said registered user links to that registered users social media network.

4. A method as defined in claim 1 which further includes the step of accepting sponsors for said system and downloading said sponsors video onto said system.

5. A method as defined in claim 4 which further includes the step of issuing additional fantasy gold coins to a registered user when said registered user views a sponsor's video.

6. A method as defined in claim 1 which further includes the steps of providing a page for each league to publish the results of the wagering by the users.

7. A method as defined in claim 1 wherein any registered user can create a specific league and can establish the time for the specific league, the amount of fantasy gold coins, if any, and can determine the parameters of the league required to join the specific league and the amount of fantasy league dollars to be issued to each user who joins the specific league.

8. A method as defined in claim 7 wherein a predetermined minimum number of registered users must join before the specific league can be activated.

9. A method as defined in claim 8 wherein the maximum number of registered users who can join the specific league is predetermined.

10. A method as defined in claim 7 wherein the registered user having the largest amount of fantasy league dollars at the conclusion of the specific league is determined to be the winner of the specific league and is issued a predetermined amount of fantasy gold coins.

11. A method as defined in claim 8 wherein only the user creating the league and one other registered user selected by the user creating the league are the sole participates in the league.

12. A method defined in claim 11 wherein user creating the league must have placed a predetermined number of wagers before he can create the league.

13. A method defined in claim 12 wherein the registered user selected by the user creating the league must have placed a predetermined number of wagers before he can participate in the league.

14. An interactive fantasy wagering gaming system comprising:
1. a central processor that
a) establishes a virtual community of registered users for participating in said gaming system;
b) provides links to each users social media networks;
c) issues a predetermined amount of fantasy gold coins to each user when said user registers;
d) issues a predetermined amount of fantasy league dollars to a user when said user joins a league, said fantasy league dollars being used only for wagers by said user during the duration of that specific league;
e) tracks the number of wagers made by each user and the outcome of such wagers;
2. a data storage medium that
a) stores the rules for each league,
b) the wagers made by each registered user who has joined a league, and
c) information regarding the league; and
3. an interface connecting said central processor to said community of registered users through a communication network.
